(19) United States
(12) Patent Application Publication
(10) Pub. No.: US 2019/0087707 A1
(43) Pub. Date: Mar. 21, 2019

(54) ARTIFICIAL CONVERSATIONAL ENTITY METHODS AND SYSTEMS

(71) Applicant: ATOMIC X INC., OTTAWA (CA)

(72) Inventors: DAN CUMMINS, OTTAWA (CA); ALEXANDRE GRENIER, OTTAWA (CA); ERIC MOLLER, OTTAWA (CA)

(21) Appl. No.: 16/132,781

(22) Filed: Sep. 17, 2018

Related U.S. Application Data
(60) Provisional application No. 62/558,974, filed on Sep. 15, 2017.

(51) Int. Cl. G06N 3/00; G06N 3/08; G06F 17/27; G06F 3/0481; H04L 12/58

(52) U.S. Cl. CPC G06N 3/006; G06N 3/08; H04L 51/02; G06F 3/0481; G06F 17/2705

(57) ABSTRACT

Chatbots are automated programs which conduct a conversation via auditory or textual methods with a user and are often designed to convincingly simulate how a human would behave as a conversational partner. However, such chatbots are limited in their functionality to the database created and maintained by the chatbot provider. Accordingly, it would therefore be beneficial to provide users with an Artificial Conversational Entity that can exploit the full depth and power of the Internet by supporting a browser interface linked to the Artificial Conversational Entity such that the outputs presented to the user can be a web page or a website either associated with the provider of the Artificial Conversational Entity or independent to the Artificial Conversational Entity provider. Accordingly, in this manner the Artificial Conversational Entity becomes a user interface for a user to enter natural language queries.

### CROSS-REFERENCE TO RELATED APPLICATIONS

This application claims the benefit of priority from U.S. Provisional Patent Application 62/558,974 filed Sep. 15, 2017 entitled “Artificial Conversational Entity Methods and Systems”, the entire of contents of each being incorporated herein by reference.

### FIELD OF THE INVENTION

This invention relates to artificial conversation entity methods and systems and more particularly to online artificial conversational entities and artificial conversation entities employing artificial intelligence and/or direct web browser control.

### BACKGROUND OF THE INVENTION

A chatbot (also known as a talkbot, chatterbot, Bot, IM bot, or interactive agent) is a computer program which conducts a conversation via auditory or textual methods with a user. Such programs are often designed to convincingly simulate how a human would behave as a conversational partner. Chatbots today, are typically used in dialog systems for various practical purposes including customer service or information acquisition. Some chatterbots use sophisticated natural language processing systems, but many simpler systems scan for keywords within the input, then pull a reply with the most matching keywords, or the most similar wording pattern, from a database.

Whilst chatbots can trace their history back to the late 1960s/early 1970s it has only been in the last 5-7 years that they have begun to become familiar to the average user with the advent of SIRI (Apple™) in 2010, Google Now (Google™) in 2012, Cortana (Microsoft™) and Alexa (Amazon™) in 2015. As of today, there are still only a relatively small number of live chatbots, so-called production ready chatbots, such that even Facebook Messenger perhaps the dominant messenger platform globally with approximately 1.2 billion users has only approximately 1,000 chatbots.

However, such bots are limited in their functionality to the database created and maintained by the chatbot provider. Accordingly, the vast majority of chatbots today are for automating customer service activities or automating information acquisition and are dominated by purely text based chatbots that accept text input and provide text based answers. Even looking at the development tools and their “advanced” features we see only minor progression beyond this to audiovisual outputs, but these are still limited to the content “programmed” into the chatbot and hence providing virtual shopping assistants for retailers.

Accordingly, it would therefore be beneficial to provide users with an Artificial Conversational Entity that can exploit the full depth and power of the Internet by supporting a browser interface linked to the Artificial Conversational Entity such that the outputs presented to the user can be a web page or a website either associated with the provider of the Artificial Conversational Entity or independent to the Artificial Conversational Entity provider. Accordingly, in this manner the Artificial Conversational Entity becomes a user interface for a user to enter natural language queries.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to artificial conversation entity methods and systems and more particularly to online artificial conversational entities and artificial conversation entities employing artificial intelligence and/or direct web browser control.

In accordance with an embodiment of the invention there is provided a user interface comprising:

a conversation interface; and
a web browser user interface; wherein
a user's input to the conversation interface is parsed and results in a change of at least one of a web page and a web site rendered to a user within the web browser user interface.

In accordance with an embodiment of the invention there is provided a method comprising:

providing a conversation interface within a graphical user interface of an electronic device;
providing a web browser within the graphical user interface of the electronic device;
parsing an input from the user with a natural processing language engine;
rendering at least one of a web page and a web site to the user within the web browser in dependence upon an output of the natural processing language engine established in dependence upon the parsed user input.

In accordance with an embodiment of the invention there is provided a non-volatile non-transitory computer readable medium storing computer executable instructions for execution by a microprocessor, the instruction relating to a process comprising the steps of:

providing a conversation interface within a graphical user interface of an electronic device comprising the microprocessor;
providing a web browser within the graphical user interface of the electronic device;
parsing an input from the user with a natural processing language engine;
rendering at least one of a web page and a web site to the user within the web browser in dependence upon an output of the natural processing language engine established in dependence upon the parsed user input.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary architecture for a chatbot interface according to the prior art;

FIGS. 2A to 2E depict an exemplary design framework for a chatbot interface according to the prior art;

FIG. 3 depicts an exemplary chatbot interface according to the prior art embedding images within the displayed conversation;

FIG. 4 depicts an exemplary chatbot interface according to the prior art associated with a retail web site;

FIG. 5 depicts a network environment within which embodiments of the invention may be employed;

FIG. 6 depicts a wireless portable electronic device supporting communications to a network such as depicted in FIG. 11 and as supporting embodiments of the invention;

FIG. 7 depicts an exemplary conversation flow for an Artificial Conversational Entity (ACE) according to an embodiment of the invention;

FIGS. 8A to 8F depict an exemplary conversation flow for an ACE according to an embodiment of the invention embedded within a website and its presenting different web pages in response to user entry within the conversation;

FIG. 9A depicts an exemplary web-based communication and data transfer overview for an ACE according to an embodiment of the invention;

FIG. 9B depicts an exemplary web-based communication and data transfer overview for an ACE according to an embodiment of the invention as a state diagram;

FIG. 10 depicts a hardware description of an ACE system according to an embodiment of the invention;

FIG. 11 depicts an exemplary swimlane chart for the browser redirect flow of control for an ACE according to an embodiment of the invention;

FIG. 12A depicts the components required to implement a prior art chatbot system; and

FIG. 12B depicts the components required to implement an ACE according to an embodiment of the invention.

### DETAILED DESCRIPTION

The present invention is directed to artificial conversation entity methods and systems and more particularly to online artificial conversational entities and artificial conversation entities employing artificial intelligence and/or direct web browser control.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch. Within this document a social network is referred to by the abbreviation SOCNET.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™). Within this document social media is referred to by the abbreviation SOME.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by data relating to a subset of conditions including, but not limited to, their environment, medical condition, condition, biological condition, physiological condition, chemical condition, ambient environment condition, position condition, neurological condition, drug condition, and one or more specific aspects of one or more of these said conditions.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, heart rate, temperate, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request; said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

A “web browser” as used herein may refer to, but is not limited to, a software application for retrieving, presenting and traversing information resources on the World Wide Web. An information resource is identified by a Uniform Resource Identifier/Locator (URI/URL) that may be a web page, image, video or other piece of content. Hyperlinks present in resources enable users to easily to navigate their browsers to related resources from within the initial resource. Whilst a web browser may be primarily intended for use with the World Wide Web, they can also be used to access information provided by web servers in private networks or files in file systems.

A “hyperlink” as used herein may refer to, but is not limited to, a reference to data that a user may select within a web browser by clicking, tapping, or hovering. A hyperlink may point to a whole document or to a specific element within a document. The text that is linked from is called anchor text. A software system that is used for viewing and creating hypertext is a hypertext system, and to create a hyperlink is to hyperlink (or simply to link). A user following hyperlinks is said to navigate or browse the hypertext.

“Hypertext” as used herein may refer to, but is not limited to, text which is itself a hyperlink or includes within it one or more hyperlinks.

A “web page” (also written as web page) as used herein may refer to, but is not limited to, a document that is suitable for the World Wide Web and web browsers which may display the web page upon a display forming part of a PED and/or FED. Web page may refer to the displayed (rendered) content or it may also refer to a computer file, usually written in HyperText Markup Language (HTML) or comparable markup language. Web browsers coordinate the various web resource elements for the written web page, such as style sheets, scripts, and images, to present the web page. Web pages may exploit hypertext and may include a navigation bar or a sidebar menu to access other web pages via hyperlinks, often referred to as links. Upon a network, a web browser may retrieve a web page from a remote web server which may restrict access to only a private network such as a corporate intranet or it may provide access to the World Wide Web. At a lower level, a web browser may use the Hypertext Transfer Protocol (HTTP) to make such requests. A web page may be static, i.e. delivered exactly as stored as web content in the web server's file system or it may be dynamic, i.e. the web page is generated by a web application that is driven by server-side software or client-side scripting. A dynamic website pages allows a browser (the client) to enhance the web page through user input to the server.

A “website” as used herein may refer to, but is not limited to, a collection of related web pages, which may include text, audiovisual content, multimedia content etc. which are typically identified with a common domain name and are published on at least one web server. A website may be accessible via a public Internet Protocol (IP) network, such as the Internet, or a private local area network (LAN), by referencing a uniform resource locator (URL) that identifies the site. Websites may have multiple functions and can be used in various fashions including, but not limited to, a personal website, a commercial website for a company, a government website or a non-profit organization website, a website for a SOME and/or SOCNET, retailer's website, and a search engine. Websites may or may not be dedicated to a particular topic or purpose wherein all publicly accessible websites collectively constitute the World Wide Web, while private websites, such as a company's website for its employees, are typically a part of an intranet.

A “popup” (strictly a context menu, also known as a contextual menu, shortcut, popup or popup menu) is a menu in a graphical user interface (GUI) that appears upon user interaction, such as a right-click mouse operation, for example. A popup offers the user a limited set of choices that are available based upon the current state, or context, of the operating system or application to which the popup belongs. Usually the available choices are actions related to the selected object. From a technical point of view, such a context menu is a graphical control element.

A “graphical user interface” or GUI is a type of user interface that allows users to interact with electronic devices through graphical icons and visual indicators such as secondary notation, instead of text-based user interfaces, typed command labels or text navigation. The actions in a GUI are usually performed through direct manipulation and/or selection of the graphical elements forming portions of the GUI.

An “Artificial Conversational Entity” (ACE, also known as a talkbot, chatterbot, Bot, IM bot, interactive agent, chatbot) as used herein may refer to, but is not limited to, a computer program which conducts an activity, e.g. a conversation, with a user via auditory, textual or visual methods. ACEs may be employed within a range of applications, including, but not limited to, dialog systems, customer service, virtual assistants, dialog systems and information acquisition. An ACEs may operate with low complexity through identifying keywords and selecting a reply accordingly from a database with the most matching keywords or closest similar wording pattern and may be employed in applications including, but not limited to, messaging platforms, customer service applications and websites, education, toys and automating time consuming but low complexity tasks upon internal platforms of businesses and enterprises. ACE may default to a human operator when matching fails within the ACE or the subject/category/query lie outside the ACE's scope and/or database. An ACE may exploit such human responses as the basis for real-time learning by adding them to the database via evolutionary algorithms that optimise their ability to communicate based on each conversation held. An ACE may employ sophisticated natural language processing systems as a form of “weak artificial intelligence” employing specialized software or programming languages created specifically for a required narrow function. An ACE according to embodiments of the invention may exploit a general purpose conversational artificial intelligence.

“Artificial intelligence” (AI, also machine intelligence, MI) as used herein may refer to, but is not limited to, intelligence exhibited by machines rather than humans or other animals which exhibit so-called natural intelligence (NI). Within computer science AI may include “intelligent agents” which may be any device that perceives its environment and takes actions that maximize its chance of success at some goal or objective. Colloquially, the term AI is employed when a machine mimics “cognitive” functions which humans associate with other human minds, such as “learning” and “problem solving”. AI may employ one or more tools, including, but not limited to search and optimization, logic, probabilistic methods for uncertain reasoning, classifiers and statistical learning methods, neural networks, deep feedforward neural networks, deep recurrent neural networks, and control theory.

An “iframe” as used herein may refer to, but is not limited to, a software implement frame within a visual HTML Browser window allowing the window to be split into segments, each of which can show a different document, which may be stored on different servers. Optionally, interaction between windows is blocked by the web browser.

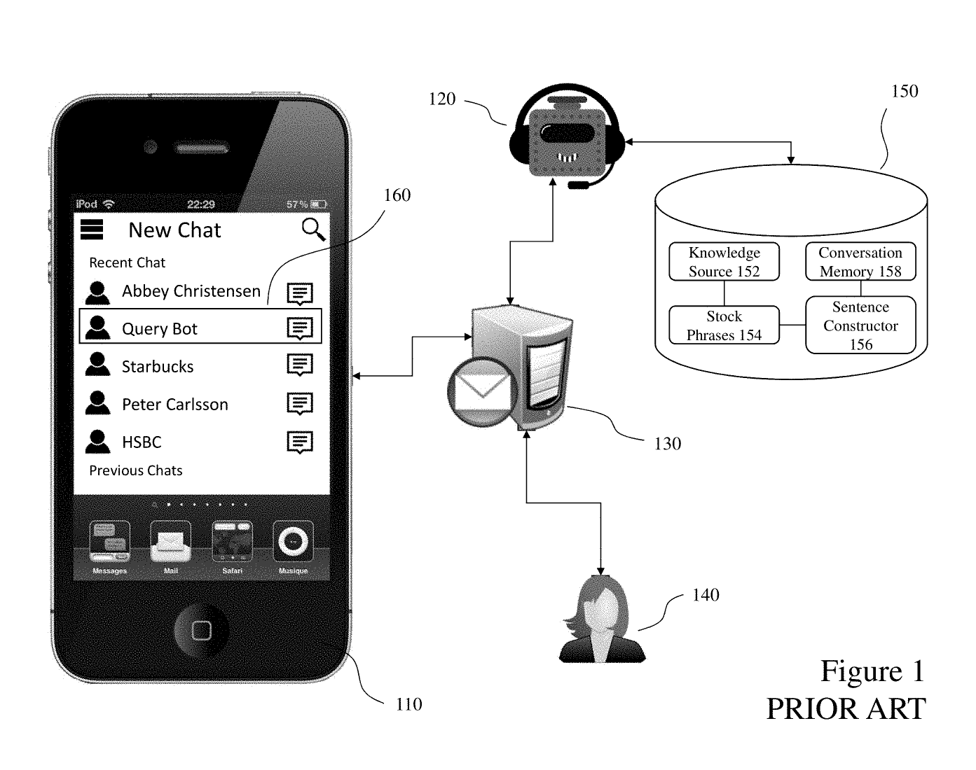

Refer to FIG. 1 depicts an exemplary architecture for a chatbot interface according to the prior art wherein a user accesses a chatbot “QueryBot” 160 which is presented as a contact within a messenger application upon their PED 110. If the user selects “QueryBot” 160 and enters a message then it is sent to a web server 130 wherein if the message can be parsed and addressed by the ChatBot 120 then it is employing data stored within a ChatBot Server 150 which comprises Knowledge Source 152, Stock Phrases 154, Sentence Constructor 156 and Conversation Memory 158. If the message cannot be parsed, then the query from the user is passed to a human user 140.

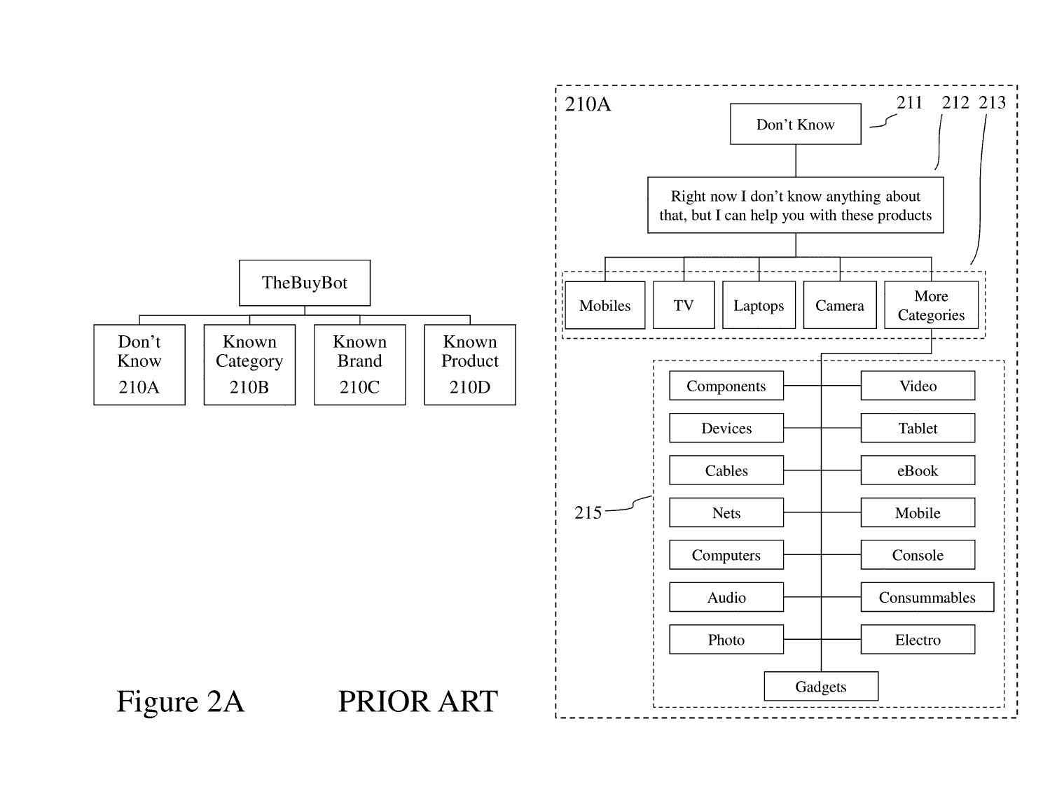

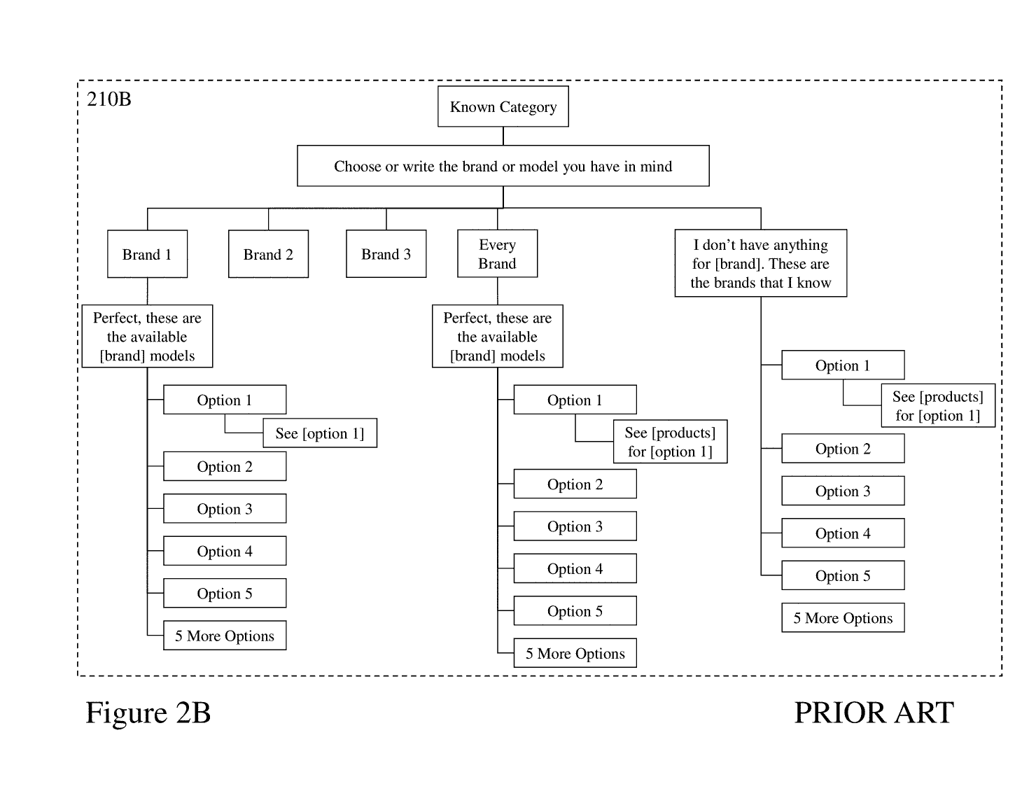

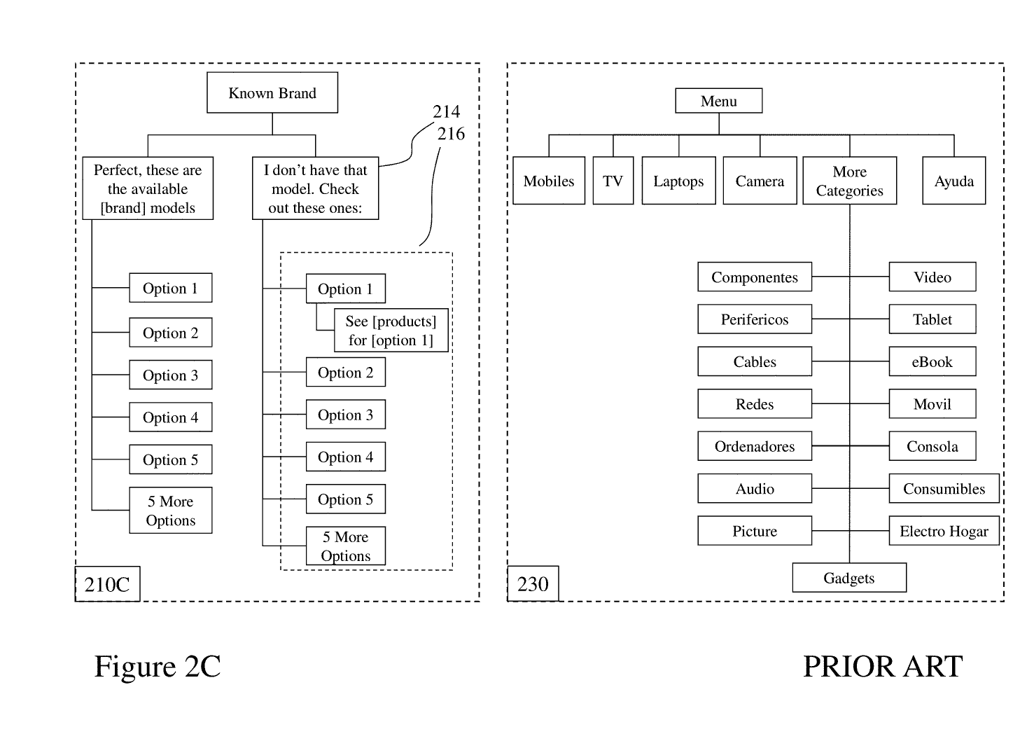

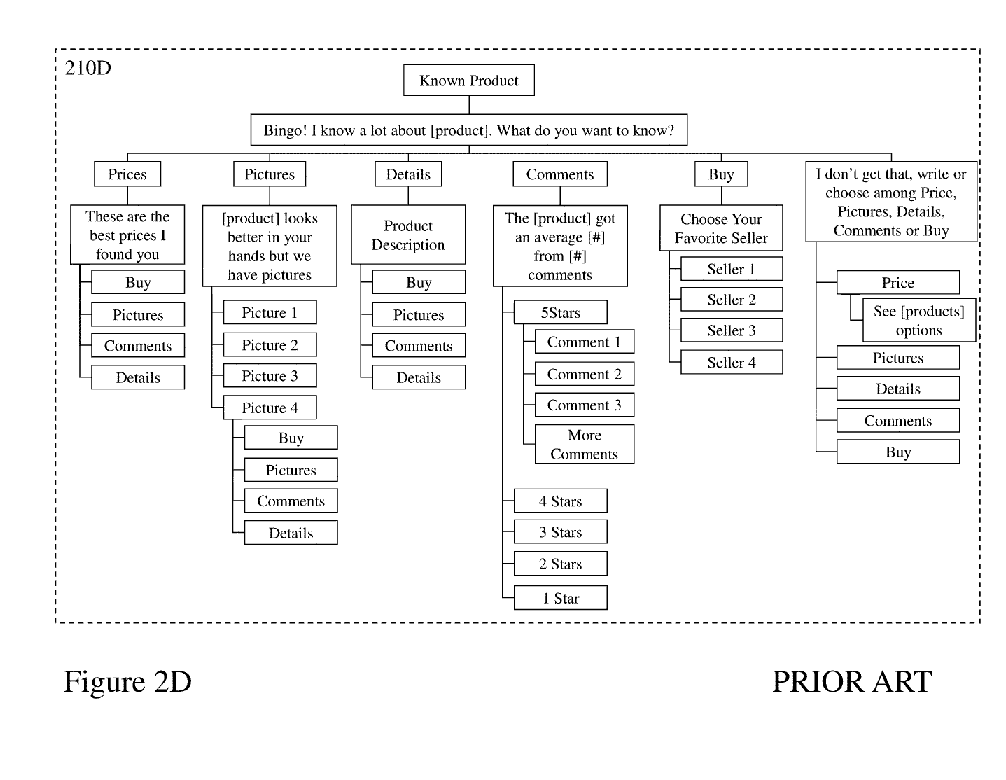

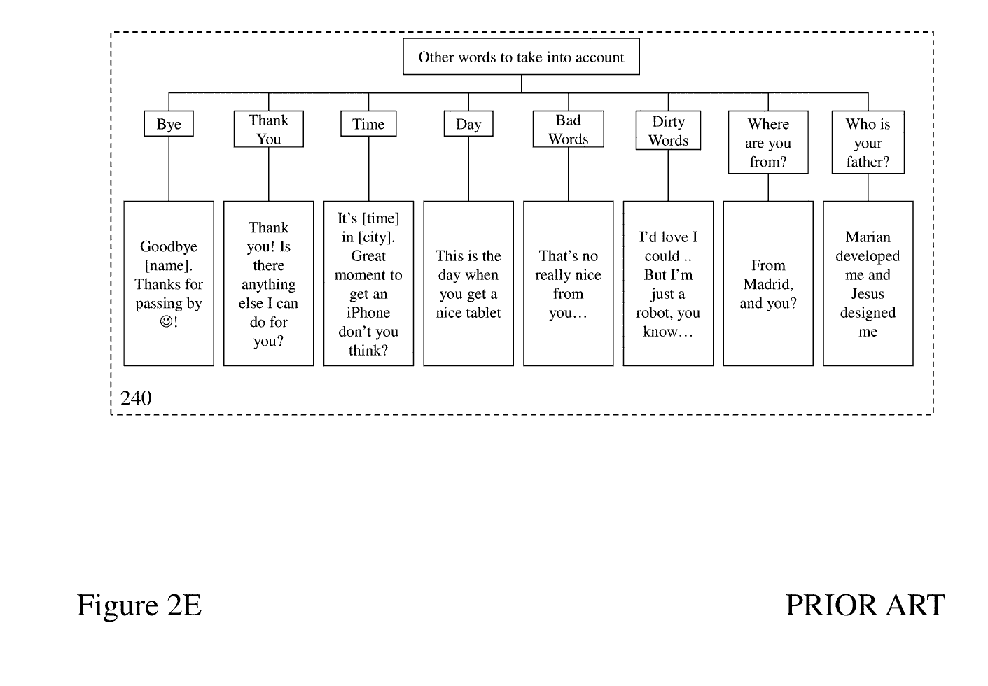

The parsing of the message by the ChatBot Server 150 is based upon a design framework established by the provider of the “QueryBot” 160. Such an exemplary design framework for a chatbot interface according to the prior art is depicted in FIGS. 2A to 2E respectively comprising first to fourth elements 210A to 210D respectively in respect of “TheBuyBot” and associated fifth and sixth elements 230 and 240 respectively. First to fourth elements 210A through 210D respectively define a structured hierarchy for options of “Don't Know”, “Known Category”, “Known Brand”, and “Known Product” respectively established in dependence upon the query parsed by “TheBuyBot” from user input. Each structured hierarchy comprising a category 211 which is matched from the text entered by the user, a chatbot positive response 212 which is provided back to the user within the interface, e.g. as a received text in the user's instant messaging application as depicted in FIG. 1. Associated with the chatbot positive response 212 are a plurality of options 213 some of which may have sub-options 215. In some instances, a failed parse of a user's input may trigger a chatbot negative response 214 which itself may have sub-options 216. Fifth element 230 presents a menu hierarchy whilst sixth element 240 lists additional words to consider within the preparation of a response to a user input but are not parsed to determine the actual response.

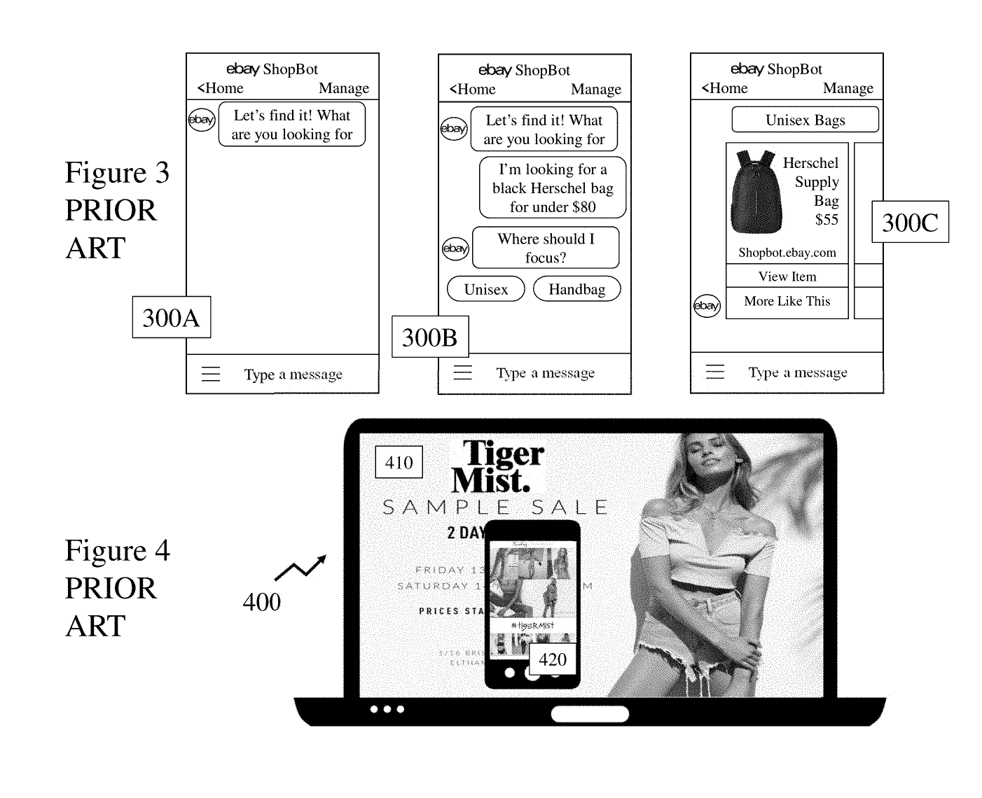

Accordingly, a conversation between a user and a retail chatbot according to the prior art, in this instance for eBay™, within a messaging application exploiting a design framework such as depicted within FIGS. 2A to 2E may therefore evolve as depicted within FIG. 3 in first to third images 300A to 300C. Accordingly, there are depicted:
First image 300A wherein the chatbot provides the query “Let's find it? What are you looking for?”;
Second image 300B wherein the user responds “I'm looking for a black Herschel bag for under $80” wherein the chatbot software parses this and identifies that “Herschel” and “bag” are recognized and that there are 2 categories of bags “unisex bags” and “handbags and purses” wherein the chatbot responds to the user with “Where should I focus?” and provides buttons for the user in respect of the two categories;
Third image 300C wherein the user responds “unisex bags” and the chatbot responds with “Awesome. Let's try these out” and presents a series of images which are stored within a database associated with the chatbot which are tagged “Herschel” and “unisex bag.” Each image includes a photograph of the product and identifying text associated with that specific product as well as buttons for the user to “view item” and view “more like this.”

Whilst the vast majority of chatbots within the prior art are linked to social media/social networks some are associated with a website, such as retailer website 410 as depicted in FIG. 4 wherein the chatbot interface which operates in the same manner as that described and depicted in respect of FIGS. 2A to 2E and 3 except that rather than the chatbot being presented to the user as a contact within a messaging application the chatbot is presented to the user as a popup. The popup is triggered by the accessing of the website or requesting a feature of the website such as help. However, these prior art chatbots are intrinsically linked to the website they are triggered from and hence close with that website being closed or any redirection of the website to another website. Optionally, the interactive window may not be a popup, but it may be provided via an animation, for example a slide in from the right of frame, or a persistent chat menu.

Accordingly, it would be beneficial for enterprises, retailers, companies and other organizations to be able to engage with their customers, suppliers, and employees with an Artificial Conversational Entity (ACE) which allows for control of the web content presented to the user either as result of the user's interaction with the ACE or as part of establishing user input and/or selection as part of the user's interaction with the ACE.

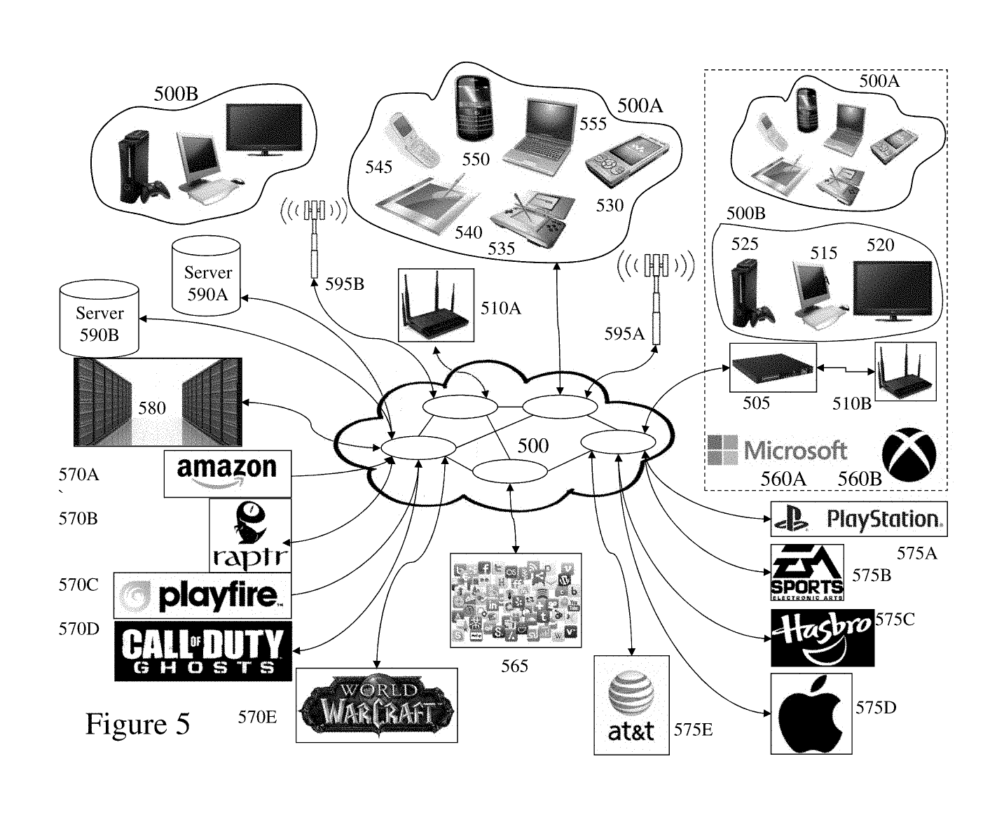

As noted in FIGS. 1 to 4 according to the prior art existing chatbots allow for an operator/owner of the chatbot (host) to send text, images, video, or simple interactive content such as buttons via a standard chat platform, e.g. Messenger™, Skype™, or an iFrame within a website. These may be entirely automated, or they may have a “human takeover” feature where a human takes over the chat either at the request of the user or where the conversation reaches the limit of the knowledge based established for the chatbot. Accordingly, referring to FIG. 5 there is depicted a network environment within which embodiments of the invention may be employed supporting Artificial Conversational Entity (ACE) systems, applications, and platforms (ACESAPs) according to embodiments of the invention. As shown first and second user groups 500A and 500B respectively interface to a telecommunications network 500. Within the representative telecommunication architecture, a remote central exchange 580 communicates with the remainder of a telecommunication service provider's network via the telecommunications network 500 which may include for example long-haul OC-48/OC-192 backbone elements, an OC-48 wide area network (WAN), a Passive Optical Network, and a Wireless Link. The central exchange 580 is connected via the telecommunications network 500 to local, regional, and international exchanges (not shown for clarity) and therein through network 500 to first and second cellular APs 595A and 595B respectively which provide Wi-Fi cells for first and second user groups 500A and 500B respectively. Also connected to the telecommunications network 500 are first and second Wi-Fi nodes 510A and 510B, the latter of which being coupled to telecommunications network 500 via router 505. Second Wi-Fi node 510B is associated with Environment 560, such as a business Microsoft™ 560A for example or a business unit, e.g. Microsoft™ Xbox™ 560B, within which other first and second user groups 500A and 500B are disposed. Second user group 500B may also be connected to the telecommunications network 500 via wired interfaces including, but not limited to, DSL, Dial-Up, DOCSIS, Ethernet, G.hn, ISDN, MoCA, PON, and Power line communication (PLC) which may or may not be routed through a router such as router 505.

Within the cell associated with first AP 510A the first group of users 500A may employ a variety of PEDs including for example, laptop computer 555, portable gaming console 535, tablet computer 540, smartphone 550, cellular telephone 545 as well as portable multimedia player 530. Within the cell associated with second AP 510B are the second group of users 500B which may employ a variety of FEDs including for example gaming console 525, personal computer 515 and wireless/Internet enabled television (SmartTV) 520 as well as cable modem 505. First and second cellular APs 595A and 595B respectively provide, for example, cellular GSM (Global System for Mobile Communications) telephony services as well as 3G and 4G evolved services with enhanced data transport support. Second cellular AP 595B provides coverage in the exemplary embodiment to first and second user groups 500A and 500B. Alternatively the first and second user groups 500A and 500B may be geographically disparate and access the telecommunications network 500 through multiple APs, not shown for clarity, distributed geographically by the network operator or operators. First cellular AP 595A as shown provides coverage to first user group 500A and environment 570, which comprises second user group 500B as well as first user group 500A. Accordingly, the first and second user groups 500A and 500B may according to their particular communications interfaces communicate to the telecommunications network 500 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 500A may form associations either through standards such as IEEE 802.15 and Bluetooth as well in an ad-hoc manner.

Also connected to the telecommunications network 500 are SOCNETS 565, personal service provider, e.g. Amazon™, first and second communities 570B and 570C respectively, e.g. Raptr™ and Playfire™, first to second online resources 570D and 570E respectively, e.g. Call of Duty™ Ghosts and World of Warcraft™, as well as first and second servers 590A and 590B which together with others, not shown for clarity. Also connected are original equipment manufacturer (OEM) 575A, e.g. Sony™ maker of the PlayStation, a software provider 575B, e.g. Electronic Arts™ (EA), a toy manufacturer 575C, e.g. Hasbro™, an electronics OEM 575D, e.g. Apple™, and telecom service provider 575E, e.g. AT&T. Accordingly, a user employing one or more ACESAPs may through a web browser upon their PED or FED interact with one or more providers, enterprises, and third parties of which those referred to in FIG. 5 are merely examples as any website may support an ACESAP according to an embodiment of the invention to which the user has access via the Internet, Intranet, corporate network, etc.

First and second servers 590A and 590B may host according to embodiments of the inventions multiple services associated with a provider of Artificial Conversational Entity (ACESAP) systems, applications, and platforms (ACESAPs); a provider of a SOCNET or Social Media (SOME) exploiting ACESAP features; a provider of a SOCNET and/or SOME not exploiting ACESAP features; a provider of services to PEDS and/or FEDS; a provider of one or more aspects of wired and/or wireless communications; an Environment 560 exploiting ACESAP features; license databases; content databases; image databases; content libraries; customer databases; websites; and software applications for download to or access by FEDs and/or PEDs exploiting and/or hosting ACESAP features. First and second primary content servers 590A and 590B may also host for example other Internet services such as a search engine, financial services, third party applications and other Internet based services.

Accordingly, a user may exploit a PED and/or FED within an Environment 560, for example, and access one of the first or second primary content servers 590A and 590B respectively to perform an operation such as accessing/downloading an application which provides ACESAP features according to embodiments of the invention; execute an application already installed providing ACESAP features; execute a web based application providing ACESAP features; or otherwise access content providing ACESAP features. Similarly, a user may undertake such actions or others exploiting embodiments of the invention exploiting a PED or FED within first and second user groups 500A and 500B respectively via one of first and second cellular APs 595A and 595B respectively and first Wi-Fi nodes 510A.

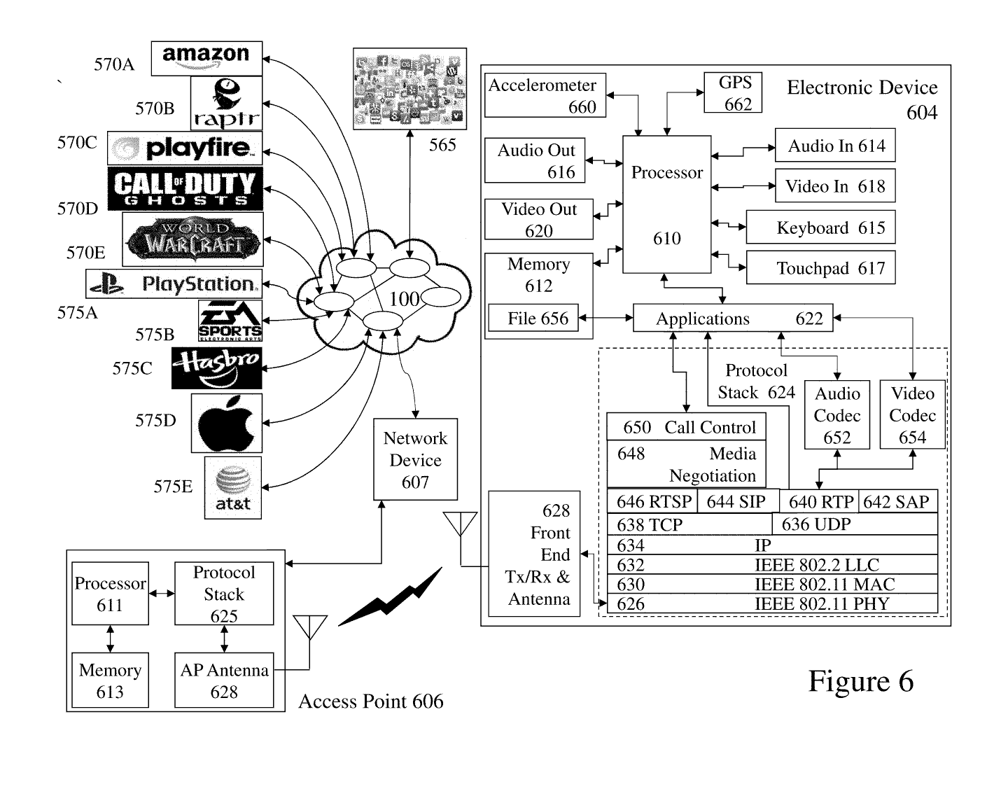

Now referring to FIG. 6 there is depicted an ELectronic DEVice (ELDEV) 604, for example a PED or FED, and network access point 607 supporting ACESAP features according to embodiments of the invention. ELDEV 604 may, for example, be a PED and/or FED and may include additional elements above and beyond those described and depicted. Also depicted within the ELDEV 604 is the protocol architecture as part of a simplified functional diagram of a system 600 that includes an ELDEV 604, such as a smartphone 550 or gaming console 565, an access point (AP) 606, such as first AP 510A, and one or more network devices 607, such as communication servers, streaming media servers, and routers for example such as first and second servers 590A and 590B respectively.

Network devices 607 may be coupled to AP 606 via any combination of networks, wired, wireless and/or optical communication links such as discussed above in respect of FIG. 5 as well as directly as indicated. Network devices 607 are coupled to telecommunications network 500 and therein SOCNETS 565, Also connected to the telecommunications network 500 are Social Networks (SOCNETS) 565, personal service provider, e.g. Amazon™, first and second communities 570B and 570C respectively, e.g. Raptr™ and Playfire™, first to second online resources 570D and 570E respectively, e.g. Call of Duty™ Ghosts and World of Warcraft™, as well as first and second servers 590A and 590B which together with others, not shown for clarity. Also connected are OEM 575A, e.g. Sony™ maker of the PlayStation, software provider 575B, e.g. Electronic Arts™ (EA), a toy manufacturer 575C, e.g. Hasbro™, an electronics OEM 575D, e.g. Apple™, and telecom service provider 575E, e.g. AT&T. Accordingly, a user employing one or more ACESAPs may through their avatar and/or avatar characteristics interact with one or more such providers, enterprises, and third parties. The ELDEV 604 is depicted as coupled to the AP 606 via a wireless link. However, it would be evident that the ELDEV 604 and AP 606 may be connected by a wired link or an optical link.

The ELDEV 604 includes one or more processors 610 and a memory 612 coupled to processor(s) 610. Similarly, AP 606 also includes one or more processors 611 and a memory 613 coupled to processor(s) 611. A non-exhaustive list of examples for any of processors 610 and 611 includes a central processing unit (CPU), a digital signal processor (DSP), a reduced instruction set computer (RISC), a complex instruction set computer (CISC) and the like. Furthermore, any of processors 610 and 611 may be part of application specific integrated circuits (ASICs) or may be a part of application specific standard products (ASSPs). A non-exhaustive list of examples for memories 612 and 613 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

ELDEV 604 may include an audio input element 614, for example a microphone, and an audio output element 616, for example, a speaker, coupled to any of processors 610. ELDEV 604 may include a video input element 618, for example, a video camera or camera, and a video output element 620, for example an LCD display, coupled to any of processors 610. ELDEV 604 also includes a keyboard 615 and touchpad 617 which may for example be a physical keyboard and touchpad allowing the user to enter content or select functions within one of more applications 622. Alternatively, the keyboard 615 and touchpad 617 may be predetermined regions of a touch sensitive element forming part of the display within the ELDEV 604. The one or more applications 622 that are typically stored in memory 612 and are executable by any combination of processors 610. ELDEV 604 also includes accelerometer 660 providing three-dimensional motion input to the process 610 and GPS 662 which provides geographical location information to processor 610.

Each of the ELDEV 604 and AP 606 include protocol stacks, namely ELDEV protocol stack 624 and AP protocol stack 625 respectively. Within ELDEV 604 protocol stack 624 is shown as IEEE 802.11 protocol stack but alternatively may exploit other protocol stacks such as an Internet Engineering Task Force (IETF) multimedia protocol stack for example. Likewise, AP stack 625 exploits a protocol stack but is not expanded for clarity. Elements of ELDEV protocol stack 624 and AP protocol stack 625 may be implemented in any combination of software, firmware and/or hardware. ELDEV protocol stack 624 includes an IEEE 802.11-compatible PHY module 626 that is coupled to one or more Front-End Tx/Rx & Antenna 628, an IEEE 802.11-compatible MAC module 630 coupled to an IEEE 802.2-compatible LLC module 632. Protocol stack 624 includes a network layer IP module 634, a transport layer User Datagram Protocol (UDP) module 636 and a transport layer Transmission Control Protocol (TCP) module 638. In similar manner AP protocol stack 625 is coupled to AP antenna 628 and CHARDEV protocol stack 686 is coupled to CHARDEV antenna 688.

Whilst ELDEV protocol stack 624 and AP protocol stack 625 are depicted based upon an IEEE 802.11 wireless interface the ELDEV 604 may exploit a second protocol stack, not shown for clarity, supporting a different wireless interface such as Bluetooth, NFC etc. Protocol stack 624 also includes a session layer Real Time Transport Protocol (RTP) module 640, a Session Announcement Protocol (SAP) module 642, a Session Initiation Protocol (SIP) module 644 and a Real Time Streaming Protocol (RTSP) module 646. Protocol stack 624 includes a presentation layer media negotiation module 648, a call control module 650, one or more audio codecs 652 and one or more video codecs 654. Applications 622 may be able to create maintain and/or terminate communication sessions with any of devices 607 by way of AP 606. Typically, applications 622 may activate any of the SAP, SIP, RTSP, media negotiation and call control modules for that purpose. Typically, information may propagate from the SAP, SIP, RTSP, media negotiation and call control modules to PHY module 626 through TCP module 638, IP module 634, LLC module 632 and MAC module 630.

It would be apparent to one skilled in the art that elements of the ELDEV 604 may also be implemented within the AP 606 including but not limited to one or more elements of the protocol stack 624, including for example an IEEE 802.11-compatible PHY module, an IEEE 802.11-compatible MAC module, and an IEEE 802.2-compatible LLC module 632. The AP 606 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by ELDEV 604 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

The inventors have established an Artificial Conversational Entity (ACE) which controls the web content presented to the user in response to cues and signals established by the user during their conversation with the ACESAP. As will become evident from exemplary embodiments of the invention described and depicted in respect of FIGS. 5 to 12 the ACESAP can adjust the web content displayed and/or rendered to the user in either directing/establishing the request/intent of the user and/or make suggestions and/or manage the interaction.

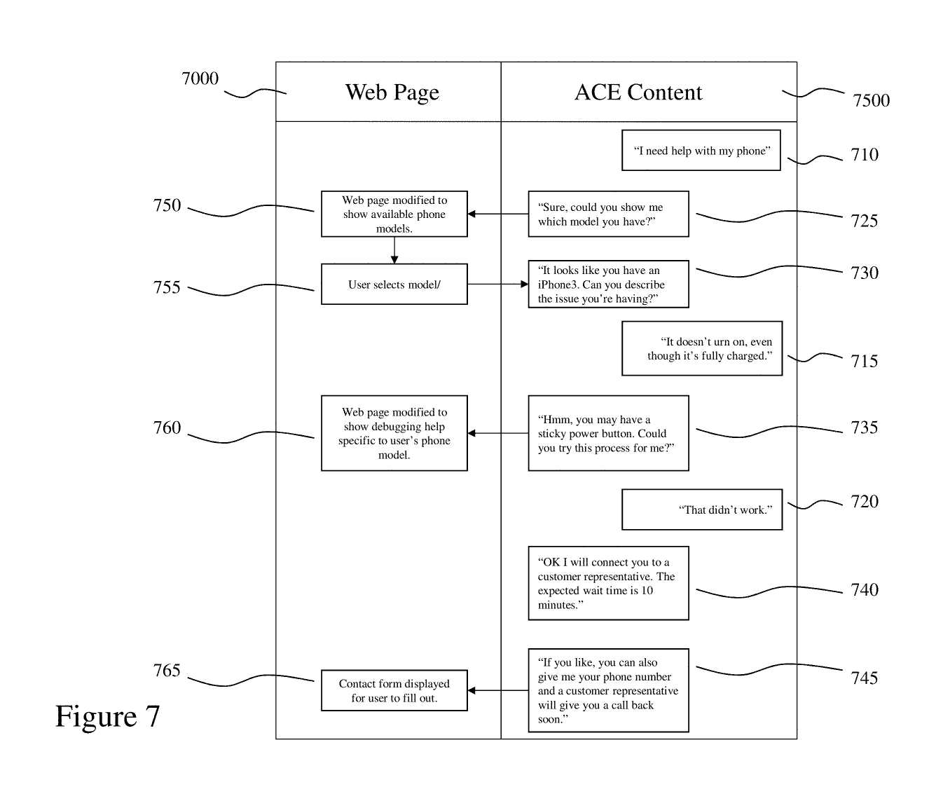

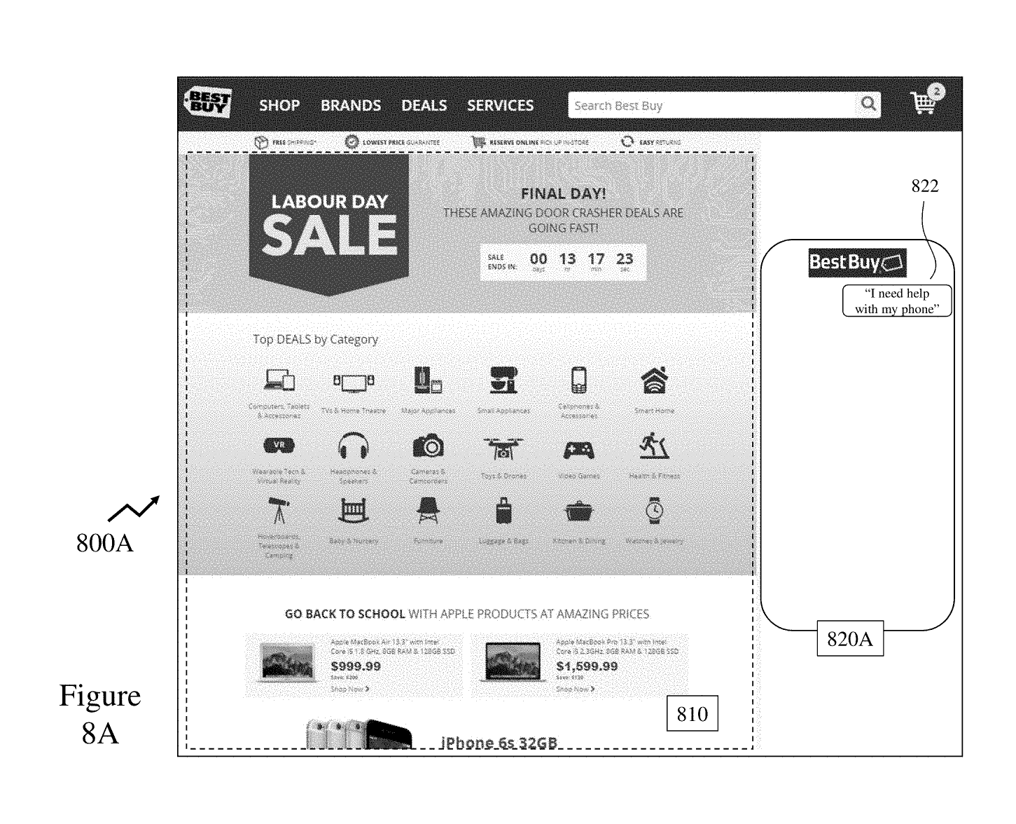

Accordingly, within embodiments of the invention an ACESAP is integrated directly within the client's website so that the user interacts with the ACESAP within the web browser rather than within a messaging application or a popup within a web page. One methodology for integrating an ACESAP is to exploit an iframe HTML element. This separates the logic of the website and the ACESAP as one iFrame element cannot access resources in another iFrame element. Accordingly, a different approach is required as outlined within the embodiments of the invention described and depicted below in respect of FIGS. 7 to 12.

Accordingly, embodiments of the invention support a paradigm shift in terms of how a user interacts with a website. The inventors have established an ACESAP and web browsing experience which provides a new interaction model for users, website(s) and those providing the website(s). An example of how a user might interact using this new ACESAP model is presented in FIG. 7 with exemplary flow 700. As depicted the user engages an ACESAP 7500 according to an embodiment of the invention which is associated with a web page 7000. Accordingly, there are depicted within the ACESAP 7500 an interleaved communications thread comprising first to third user entries 710 to 720 and first to fifth ACESAP outputs 725 to 745. These being:
First user entry 710 “I need help with my phone”;
First ACESAP output 725 “Sure, could you show me which model you have?”;
Second ACESAP output 730 “It looks like you have an iPhone3. Can you describe the issue you're having?”;
Second user entry 715 “It doesn't urn on, even though it's fully charged”;
Third ACESAP output 735 “Hmm, you may have a sticky power button. Could you try this process for me?”;
Third user entry 720 “That didn't work”;
Fourth ACESAP output 740 “OK I will connect you to a customer representative. The expected wait time is 10 minutes”; and
Fifth ACESAP output 745 “If you like, you can also give me your phone number and a customer representative will give you a call back soon.”

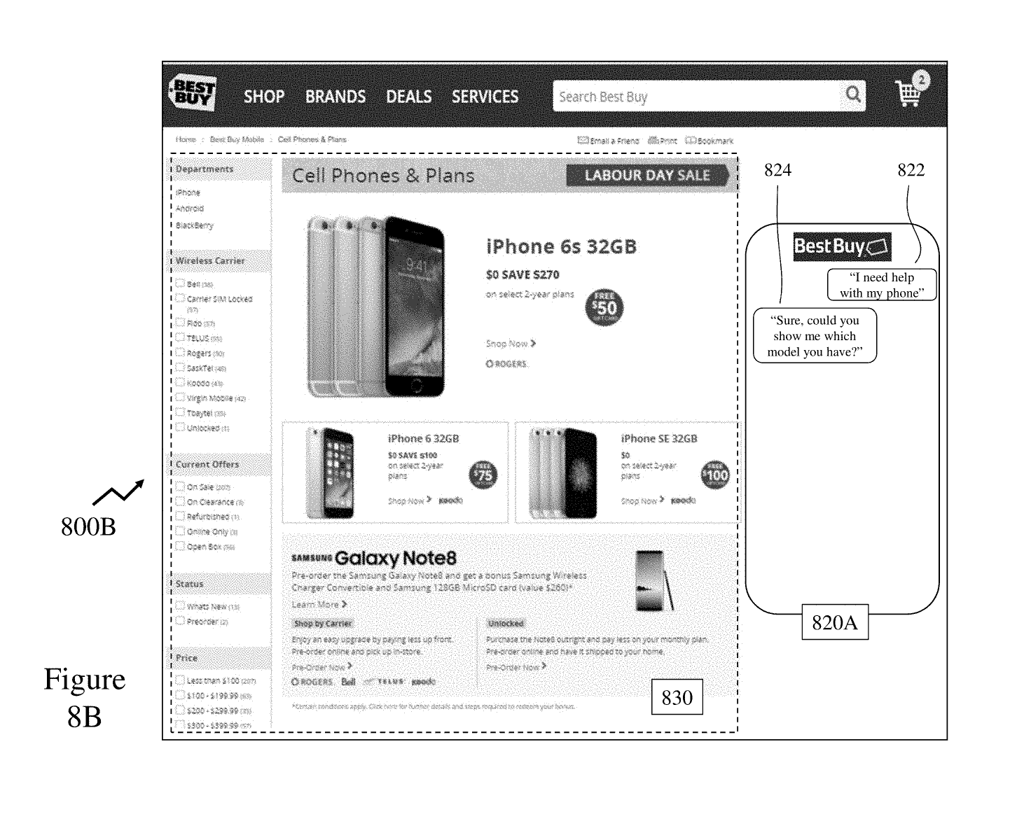

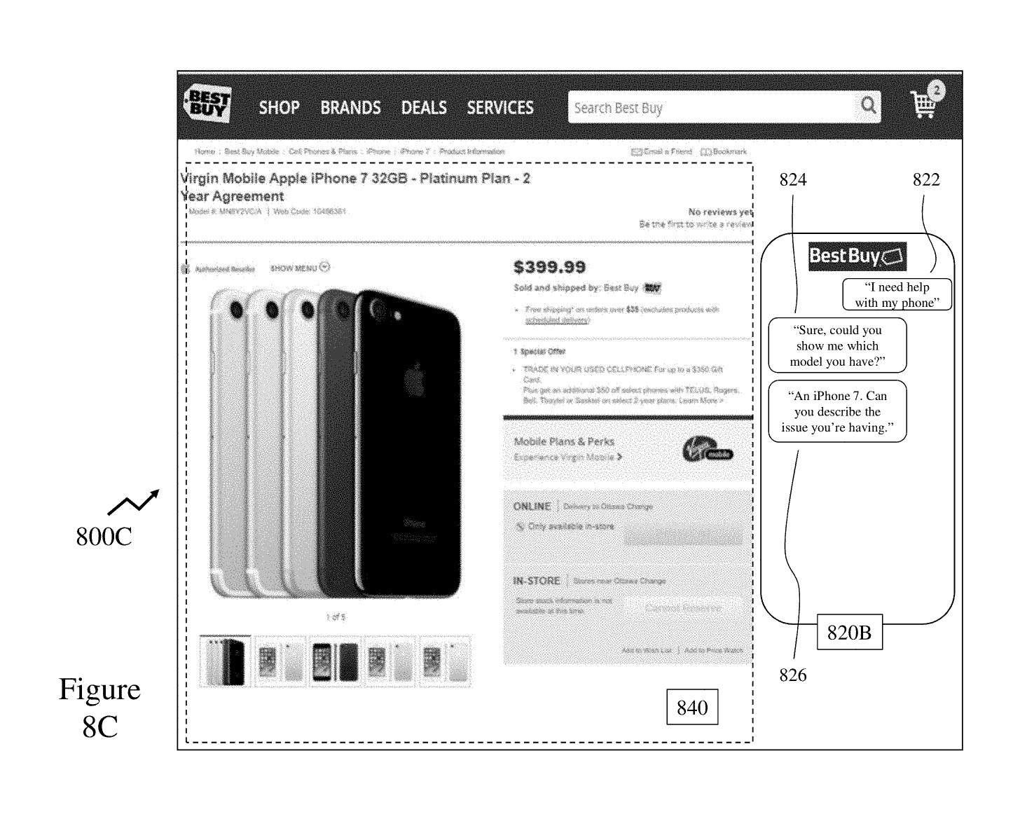

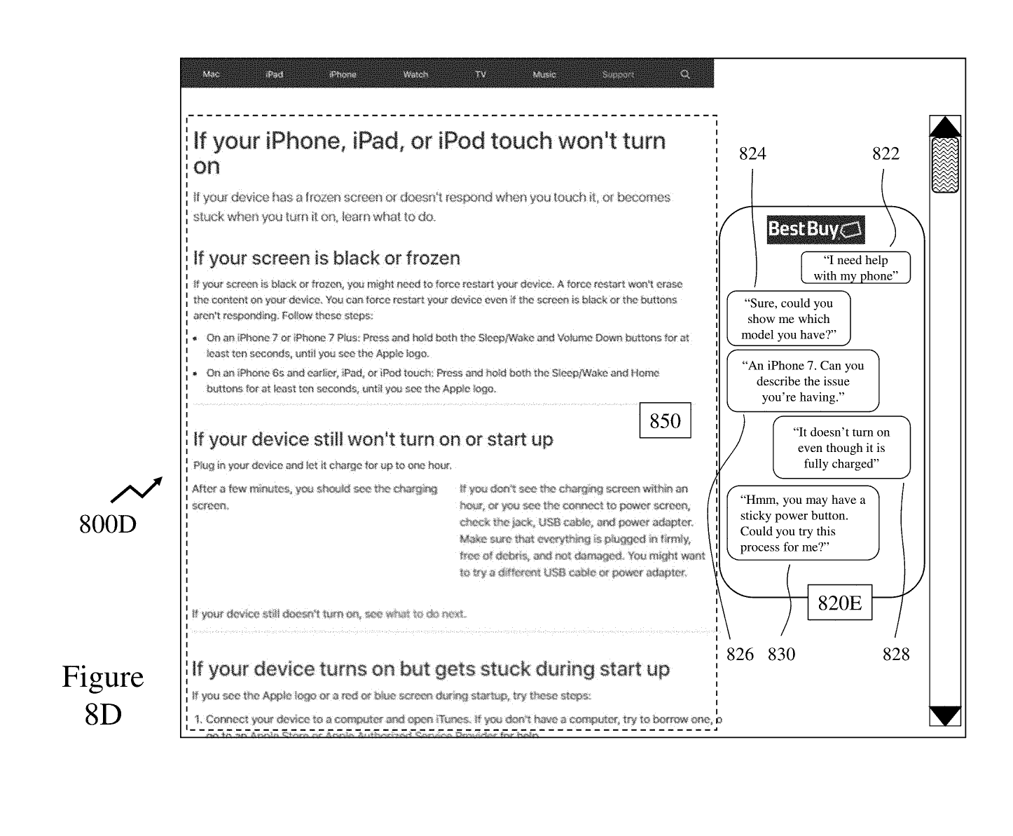

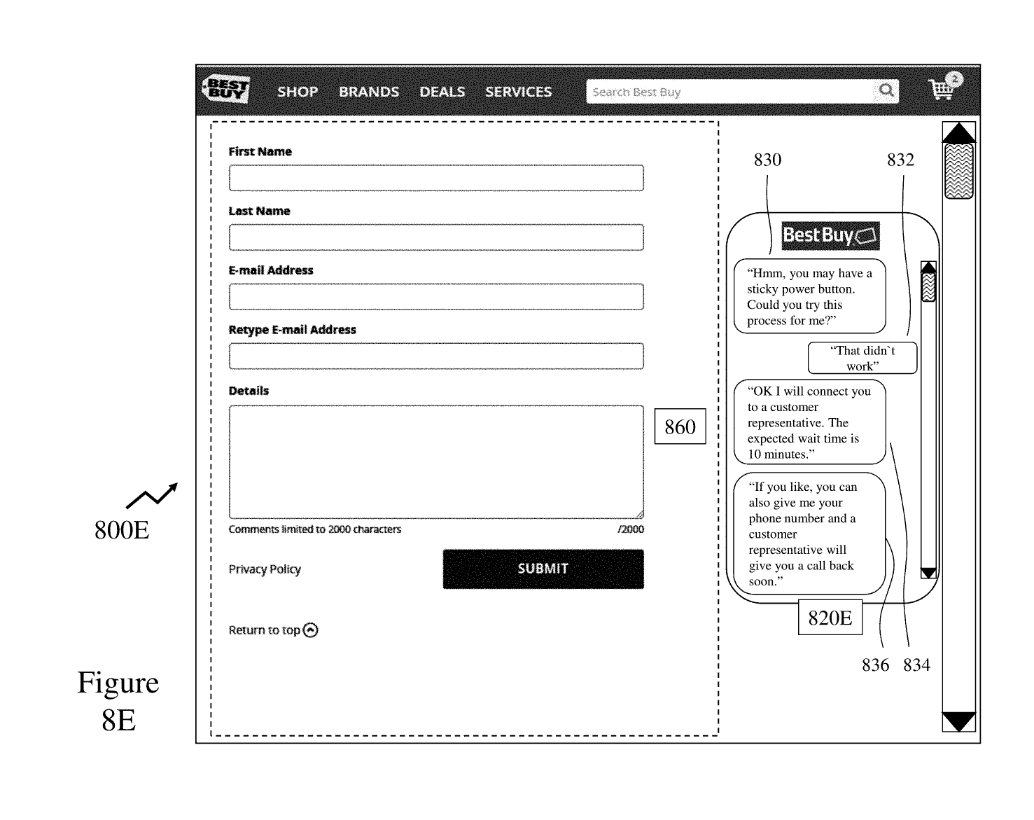

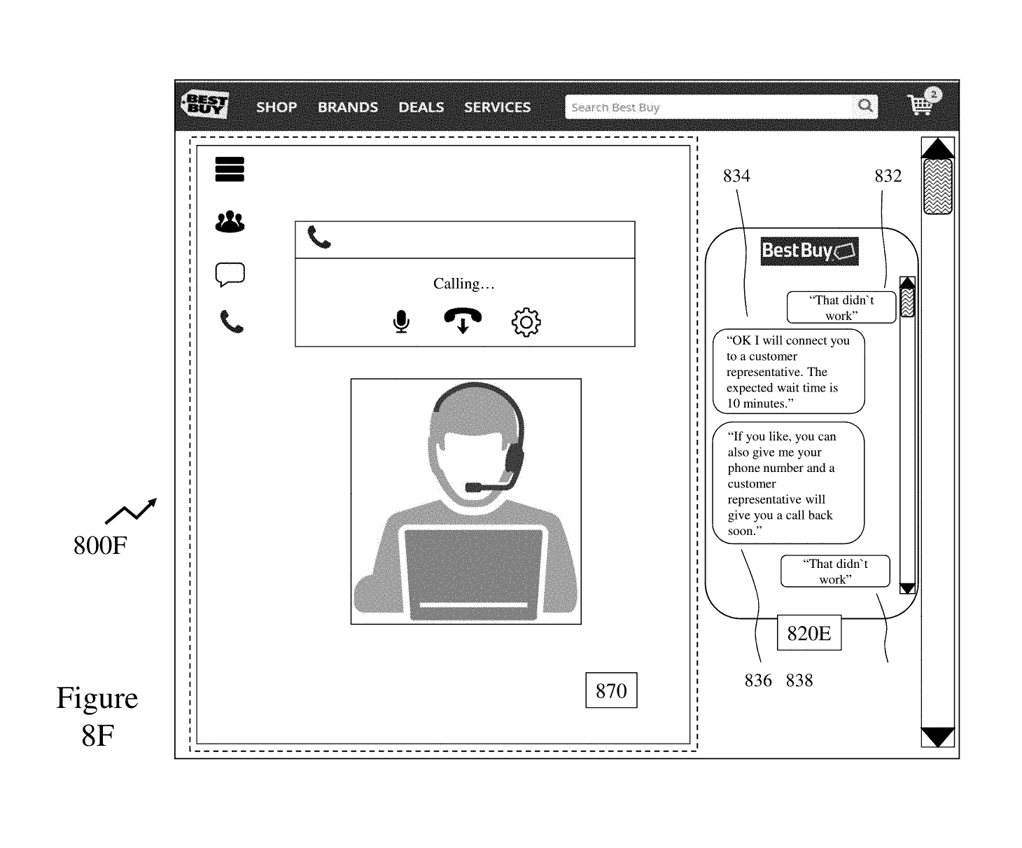

Upon presentation of the first ACESAP output 725 the user is able to employ the Web page 7000 in order to navigate within the website they accessed which triggered (or alternatively presented in response to a user trigger) the ACESAP in order to select either within a web page or by navigating to a specific web page. This being depicted by first and second web steps 750 and 755 and as depicted in the exemplary visual flow in FIGS. 8A to 8C respectively which ends with the second ACESAP output 735 being provided within the ACESAP Content 7500. Similarly, upon providing the user with the third ACESAP web step 760 where the ACESAP changes the web page displayed to a help page such as depicted within the exemplary visual flow in FIGS. 8D whilst providing third ACESAP output 735. This is also depicted within the exemplary visual flow in FIG. 8F where the ACESAP changes the web page displayed to the user to a contact entry form in combination with providing fourth and fifth ACESAP outputs 740 and 745 respectively.

Accordingly, referring to FIGS. 8A to 8F respectively there are depicted exemplary web browser images of an ACESAP according to an embodiment of the invention interacting with a user and a web site. These represent:

FIG. 8A depicts a Launch Screen 800A wherein the user has initiated communication with the ACESAP as depicted by first frame 820A with first user message 822 and first ACESAP message 824 which is a repeat of first user entry 710 in flow 700 in FIG. 7. Accordingly, the web site is at the first page 810 that the user was on when the ACESAP was triggered.

FIG. 8B depicts a product screen 800B wherein the user after initiating communication with the ACESAP receives the first response from the ACESAP as depicted by first frame 820A with first user message 822 and first ACESAP message 824 which are repeats of first user entry 710 and first ACESAP output 725 in flow 700 in FIG. 7. However, the ACESAP has now navigated to another web page within the web site, second page 830, which is the beginning of a navigation and selection process for the user to define the model of the telephone that they are seeking help for.

FIG. 8C depicts a product screen 800C wherein the user after initiating communication with the ACESAP has navigated to the telephone model that they are seeking help for as indicated in third frame 820C. Accordingly, the ACESAP has determined that the user has establish the telephone model based upon an aspect of their interaction, e.g. the time elapsed since the user navigated to that page, the user entered a recognized phrase or terms into the ACESAP such as “this one”, the ACESAP was monitoring the user's gestures and recognized a predetermined gesture relating to “done” or “completed”. In this instance the process is based upon time elapsed since the user navigated to the third page 840. Accordingly, the ACESAP provides second ACESAP message 826 which is a repeat of second ACESAP output 730 in flow 700 in FIG. 7 indicating the selected product and seeking the user's next input through a directed question.

FIG. 8D depicts a product screen 800D wherein the user has now provided the ACESAP with an outline of the issue as depicted by fourth frame 820D that they have with second user message 828 which is followed by third ACESAP output 830 which are repeats of second user entry 715 and third ACESAP output 735 in flow 700 in FIG. 7. However, the ACESAP has now navigated to another web page within another web site, fourth page 850, which is the help screen for turning on an iPhone on the Apple™ website, being the OEM of the iPhone. Accordingly, the ACESAP whilst launched within a first web page has now control of the web page such that it can render the information from another web page and website whilst maintaining that is itself associated with the original website.

Optionally, the navigation may be within the same web site as that from which the ACESAP was launched or alternatively each page may be from a different website and the ACESAP parses the content to establish the current location and information. Accordingly, in the example provided by FIGS. 8A to 8F the user may elect to identify the phone (in this instance) by entering the product name into the ACESAP but where they do not know or there are multiple options/alternates etc. then the user may exploit web pages and/or web sites to achieve the required selection. Hence, rather than limiting the user to navigating a web site that they may not be that familiar with the ACESAP according to embodiments of the invention allows them to navigate via a website they are familiar with.

Now referring to FIG. 8E there is depicted a customer enquiry form 800E wherein the user has now provided the ACESAP with further information as has the ACESAP. Accordingly, the user has stated that the identified solution provided to the user did not work and hence the ACESAP has notified the user that they can be connected with a customer representative but that there is a wait or alternatively they can leave their details and the customer representative will call them back. In this instance the ACESAP defaults to the enquiry form to be displayed but if the user elected to be connected to the customer representative then the user may be provided with a VOIP interface such as Google™ Hangouts, Skype™ etc.

Accordingly, the ACESAP as depicted by fifth frame 820E has third user message 832 which is followed by fourth and fifth ACESAP outputs 834 and 836 respectively which are repeats of third user entry 720 and fourth and fifth ACESAP outputs 740 and 745 respectively in flow 700 in FIG. 7. In this instance the ACESAP defaults to the enquiry page 860 of its web site. Alternatively, as depicted in FIG. 8F with VOIP interface 800F if the user provided a fourth user message 838 “Connect” then the ACESAP controls the web page to a VOIP application online 870, e.g. a white labelled VOIP package provided for web site owner or an independent commercial VOIP where the web site owner covers any costs through an agreement with the VOIP application provider.

Accordingly, the inventors have established a three-way (3-way) interaction model between the user, a web page, and ACESAP. This allows for multiple new interaction models to occur on the web page. The ACESAP may, for example, be used as a helpful agent on a web site, as a teacher on another web site, as a way for a user to provide feedback on what they see or experience on a web page. By allowing the ACESAP to control (and be controlled by) the main page content the inventors expand the current interaction model beyond simple text-based communication. Accordingly, this addresses a key problem, as often users are fatigued from typing, or would like to experience a more visual/traditional web experience. Accordingly, embodiments of the invention lead to greater engagement and a more immersive automated ACESAP experience.

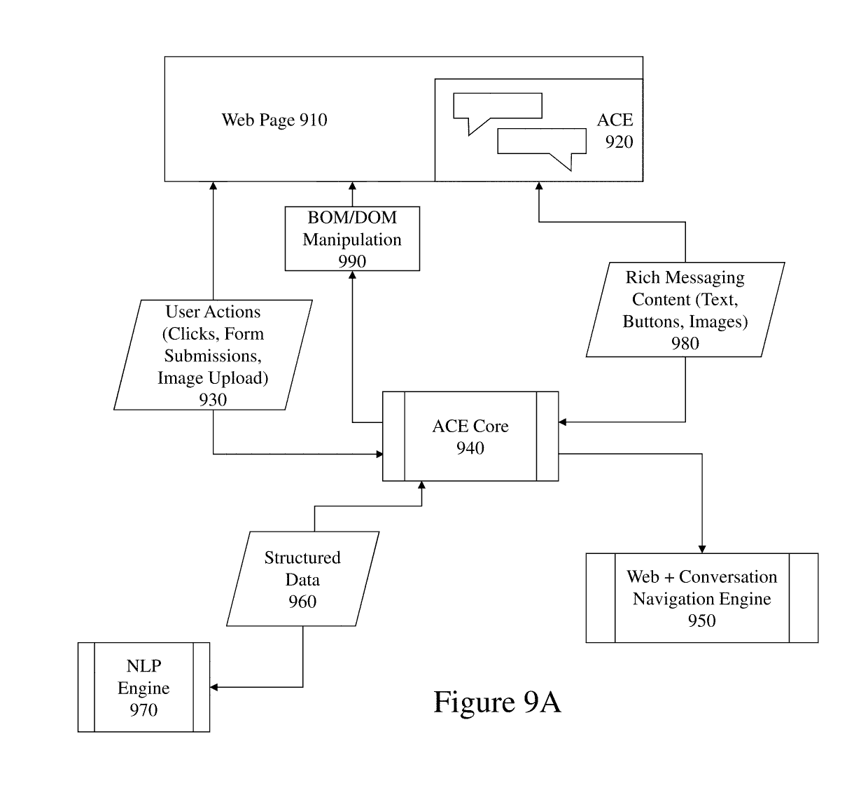

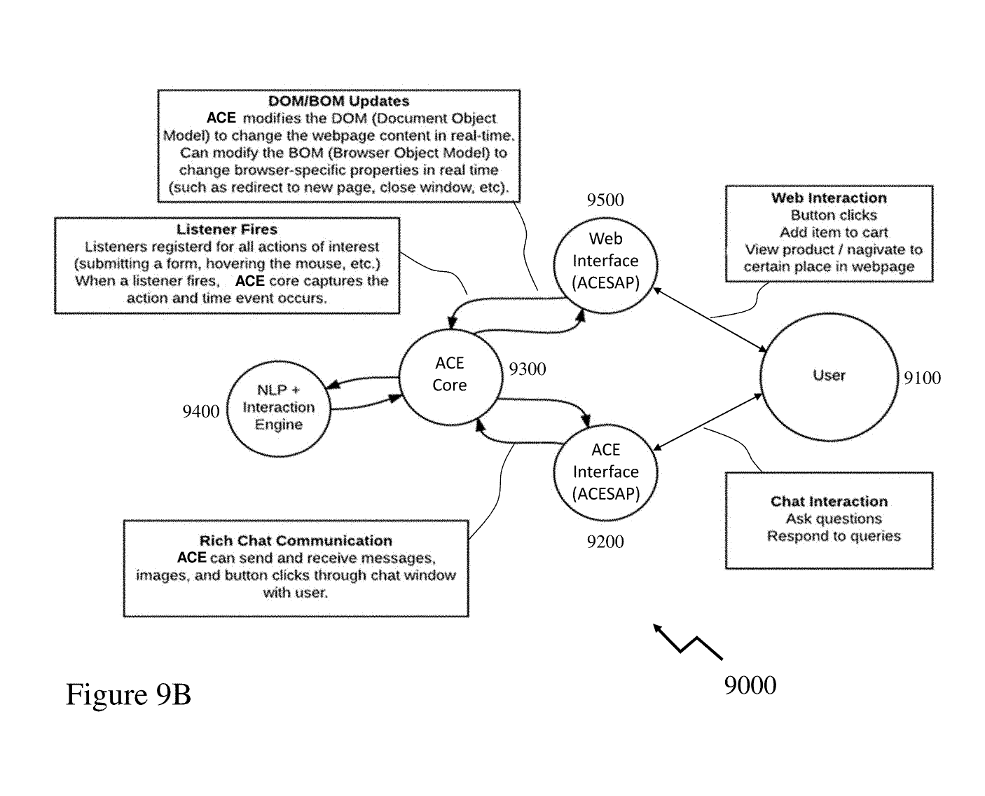

The inventors achieve this by hosting the ACESAP as part of the parent web site, as opposed to placing the ACESAP inside a separate iFrame element. There are accordingly, several non-trivial challenges to overcome when doing this. In FIG. 9A below, the inventors describe the core components and communication channels employed within an embodiment of the invention. Accordingly, there is depicted a Web Page 910 with an ACESAP 920. The ACESAP 920 supports Rich Messaging Content 980, for example buttons, text, images, etc. which interacts with an ACESAP, which the inventors refer to ACE Core 940. ACE Core 940 is connected to a Natural Language Processing (NLP) Engine 970 for parsing the user's messages entered within the ACESAP 920. ACE Core 940 also interfaces with a Web+Conversation Navigation Engine 950 which establishes response options and/or web pages for the ACESAP 920 and Web Page 910. These being provided through User Actions 930, such as click options, form submissions, image uploads, etc. ACE Core 940 also manages manipulation of the Browser Object Model (BOM) and Document Object Model (DOM) for modifying the existing web site content.

With an embodiment of the invention the ACE Core 940 is a software application hosted and executed upon a web server which provides services to the main browser window via JavaScript (JS) import. The ACE Core 940 communicates with the NLP Engine 970 which provides Structured Data 960. NLP Engine 970 may be hosted upon the same server as ACE Core 940, upon another server associated with the same provider as the ACE Core 940, or upon another server associated with another independent provider to the provider of the ACE Core 940. The NLP Engine 970 parses text and resolves the user's intent as well as numbers, names, labels, etc. provided. Structured Data 960 is returned to the ACE Core 940. This Structured Data 960 from the NLP Engine 970 is used to advance the dialog state of the Web+Conversation Navigation Engine 950. This may, within an embodiment of the invention, be a tree-based structure that dictates which possible web pages/content or responses can be provided to the user given a user input. It may also be possible to bundle the NLP and Interaction Navigation services into one program/call.

The “ACE” program, an ACESAP according to an embodiment of the invention, can be imported into the main web page content of a web page opened by the user, which allows it to display the ACE ACESAP window. It can alter the DOM (Document Object Model) which allows the “ACE” core to modify existing web page content. It can also alter the BOM (Browser Object Model) which allows “ACE” to perform actions on the user's browser, such as resize the window, or redirect the browser to a new page. Additionally, “listener modules” can be established which “trigger” or “fire” when predetermined web actions are undertaken, such as the click of a certain button, reaching the end of a web page, etc. Accordingly, “ACE” differs from the prior art chatbots in that the embodiments of the invention provide for an ACESAP that:
is presented within the website, such as through the use of a JavaScript include statement for example;
modifies HTML content on the page it is imported into, e.g. modify the DOM; and
directly control the browser and support ACESAP redirected transfers or user directed transfers to another web page or website.

Embodiments of the invention allow for the web page to not necessarily be a subpage of the initially launched web page as well as for the other web pages directed to be hosted upon completely different servers as the ACESAP can modify the BOM.

Whilst embodiments of the invention may load and render web pages that are not associated with an ACESAP according to an embodiment of the invention alternate embodiments of the invention may also load web pages that also have an ACESAP as with the call to the new web page the ACESAP can seamlessly reload the chat window and continue the conversation where it was left off. Alternatively, an ACESAP may when navigating to a web page that does not have ACESAP integration end the communication session and leave the user at the web page without ACESAP. Accordingly, an ACESAP according to embodiments of the invention may modify an existing web page BOM to include the ACESAP so that an existing web page is modified to render the ACESAP or alternatively the ACESAP may have its own BOM modified so that the web page with the ACESAP renders the web page to be rendered within a window comprising an existing ACESAP. ACESAP configuration settings of the ACESAP may be set to perform either in some embodiments of the invention or one or other. In a more complex scenario “ACE” may switch between these modes according to whether the web page navigated to has and/or supports an ACESAP or does not.

Optionally, the ACESAP may be an application associated within its own rights allowing a browser to be provided supporting ACESAP functionality and providing the user with the ability to access web pages with or without pre-existing ACESAP functionality within a common graphical user interface (window).

Optionally, within embodiments of the invention the web browser, web pages, and ACESAP window may be loaded exploiting a JavaScript library such as “Lightbox”, for example, which displays images/videos etc. by filling the PED and/or FED display screen and dimming out the rest of the web page.

As noted supra an ACESAP according to an embodiment of the invention can monitor the actions of the user and trigger/fire actions as a result. These may be ACESAP related actions and/or web page related actions. For example, when reaching the bottom of an article, an ACESAP according to an embodiment of the invention may “load” or appear to “popup” and ask the user what they thought about it. As the ACESAP can direct content rendered then the user may be presented with different web pages based upon their response or provided further ACESAP related actions.

As noted the exemplary embodiment of the invention depicted in FIG. 9A employs an NLP Engine. An NLP Engine is intended to parse and understand text input. It cannot parse a complex web actions such as the user hovering a cursor over an area of the web page or checking if the window has a focus for example. By separating the web navigation and NLP layers within an ACESAP according to embodiments of the invention the ACESAP can modify its behavior and responses in response to complex web actions, as opposed to only text or button input.

Accordingly, in contrast to the prior art, wherein a chatbot provides predetermined content based upon a parsed user input and may only access external web pages using clickable links, ACESAP interfaces according to embodiments of the invention streamline the process of content delivery by binding the web content to the conversation state.

Further, embodiments of the invention expand the range of possible inputs to an ACESAP. Instead of just written/spoken text and inline buttons, ACESAPs according to embodiments of the invention may have any range of inputs made possible using rich web page content. Certain responses or behaviors can be triggered by complex actions, such as hovering the cursor for a time beyond a threshold, moving a draggable item, putting an item in a cart, processing acquired visual content for gesture(s), processing aspects of PED/FED such as accelerometer, etc. Accordingly, ACESAPs according to embodiments of the invention are able exploit rich information sources that are available/accessible OUTSIDE the chat window.

ACESAPs according to embodiments of the invention combine text and browsing into a unified experience which is more complex than simply combining chat and browsing. To achieve the text and browsing combination the inventors have established ACESAPs according to embodiments of the invention that are context-aware in terms of what content is currently being displayed to the user, and the web content should adjust to reflect the ACESAP communications with the user. Further, as the ACESAPs according to embodiments of the invention access other web sites and web pages the content that is provided in respect of a query made to the ACESAP is not only dynamic but also reflects current real time information. For example, “Show me Grand Union Station” may result in the ACESAP providing the user with a webcam outside Grand Union Station, a camera feed from inside Grand Union Station, etc. The inventors build this context awareness within ACESAPs according to embodiments of the invention by passing state metadata to the NLP Engine or NLP provider. This means that when a new page is shown to the user, the context relevant to that page is reflected in the NLP or conversational engine's context settings.

Further, in order to ensure that the content provided to the user on the main page is reflective of what the ACESAP is communicating, ACESAPs according to embodiments of the invention are implemented with built-in triggers at certain conversational “trigger points”. Accordingly, when the ACESAP “offers” to show certain content, an internal listener is triggered which causes the ACESAP to update the web page displayed to the user.

These features of ACESAPs according to embodiments of the invention are depicted within FIG. 9B via a state diagram 9000 reflecting a web-based communication and data transfer overview for an ACESAP according to an embodiment of the invention. Accordingly, there are depicted a user 9100 who communicates with the ACESAP Interface 9200 and Web Interface 9500 of the ACESAP according to embodiments of the invention. Each of these have bidirectional interfaces to the ACE Core 9300 which is in bidirectional communication with the NLP+Interaction Engine 9400.

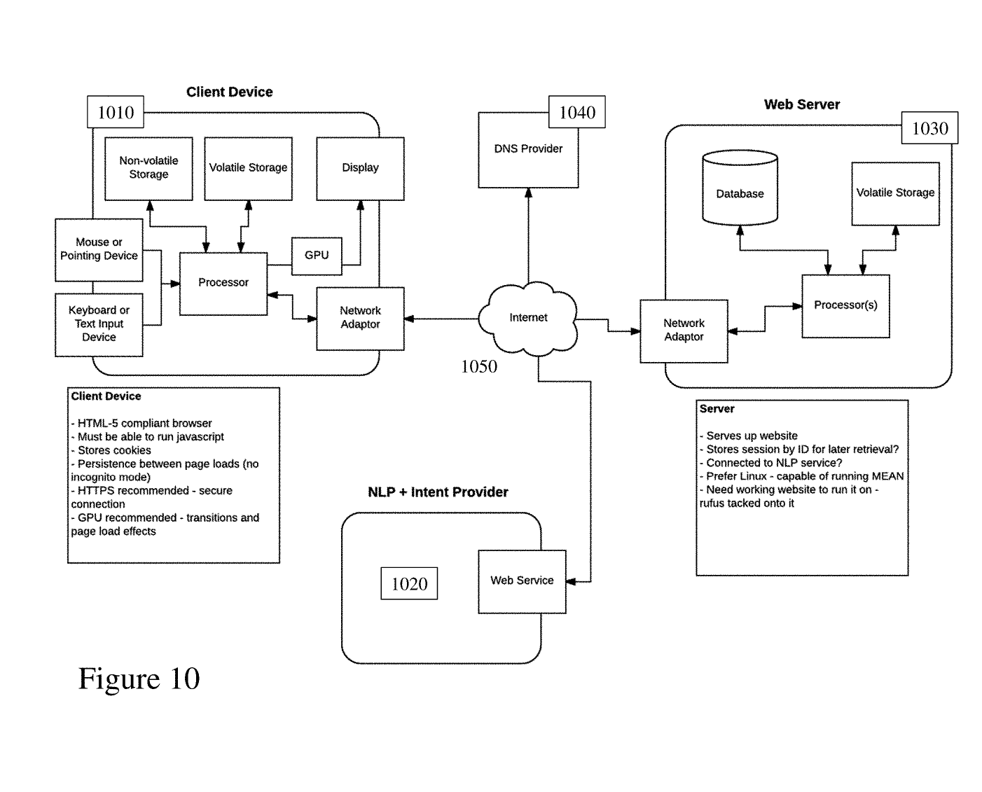

Now referring to FIG. 10 there us depicted an exemplary hardware-level description for implementing ACESAPs according to embodiments of the invention. As depicted the Client Device 1010 is a web-enabled FED or PED capable of running a client-side scripting language, which may include, but not limited to, JavaScript, Active Server Pages (ASPs), ActionScript, and Adobe™ Flash. Client Device 1010 may be a PED or FED such as ELDEV 604 in FIG. 6. There are many devices that could do this, would need an internet connection and some type of browser. For example, smart fridge, smart home system, ATM, etc.

ACESAPs according to embodiments of the invention employ Client Devices 1010 with client-side storage, e.g. cookies, and have persistence between web page loads. Initial ACESAPs according to embodiments of the invention implemented by the inventors exploit a HTML-5 compliant browser such as supported by Apple™ iPhones or a laptop computer running Microsoft™Windows 10. ACESAPs according to embodiments of the invention may be implemented on a system that responds to requests across a computer network, such as the Internet 1050, to provide or help to provide a network or data service. This may, for example be a web server, e.g. Web Server 1030; a virtual server instance, e.g. Amazon™ Web Service (AWS), a user's residential computer, or any other device which provides web data or services.

ACESAPs according to embodiments of the invention exploit a Natural Language Processing service and/or provider, e.g. NLP+Intent Provider 1020. An NLP service may be implemented in one or more ways including, but not limited to, deep learning methods, keyword based search-tree methods, etc. or even a human responding to text. This NLP+Intent Provider 1020 can be hosted within the Web Server 1030 or it may be an external service, e.g. NLP+Intent Provider 1020. Examples of current external web services providing NLP functionality are API.ai (part of Google™) or pullstring.com.

ACESAPs according to embodiments of the invention exploit an interaction navigation service which may be the same provider of the NLP service, if the NLP is using a tree-based structure, for example, or it could be a different method of tracking an interaction and its associated navigation. For example, a deep learning neural network could be trained to understand which action is most recommended in response to certain user text.

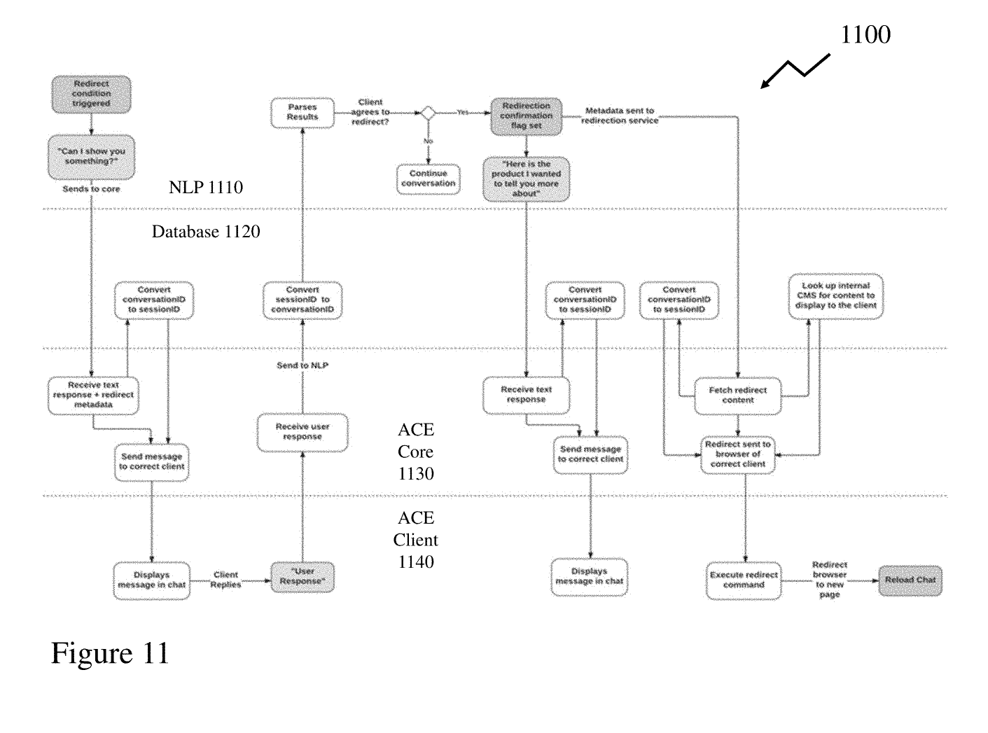

Now referring to FIG. 11 there is depicted an exemplary swimlane chart 1100 for the browser redirect flow of control for an ACESAP according to an embodiment of the invention. As depicted the swimlane chart 1100 comprises four swimlanes, these being:
NLP 1110;
Database 1120;
ACE Core 1130; and
ACESAP Client 1140.

Swimlane chart 1100 addresses the browser redirect flow of control for an ACESAP according to an embodiment of the invention. This process is actually a sub-process within the process comprising the steps of:
A client connects to a website exploiting an ACESAP according to an embodiment of the invention and initiates a conversation;
The ACESAP transfers the user input to an NLP to parse entities and intents from the user (client) input (utterances);
The NLP service has certain intents defined which trigger a redirect action;
If such a condition is triggered, the NLP service requests confirmation from the end user; and
Once the user's intent has been confirmed, the ACESAP can redirect the web browser to a different page.

As noted supra an ACESAP according to an embodiment of the invention may redirect the browser to a web page not hosted on the same server or infrastructure. Accordingly, ACESAPs according to an embodiment of the invention can be enabled to trigger specific web actions in response to specific intents or verbal cues provided by the client (user).

As an example, the client may express interest in renting a detached, two-bedroom home. Here, the ACESAP registers this as an actionable interest, and may query whether the client would like to see several options of detached two-bedroom homes. In a traditional chatbot system, the results would be presented inline, as part of the chat experience, based upon the content within the database of the chatbot. However, an ACESAP according to an embodiment of the invention may query one or more content engines for the specific request (detached two-bedroom homes) which is handled and passed back to the dispatcher. At this point the dispatch module can dynamically update the web page the ACESAP conversation is currently occurring on, and present the user with a rich, dynamic website, which can be used alongside the present chat window. In this way, the user is being presented new web content in response to expressed interests and desires. For example, this may be a web site relating to a multiple listing service of realtors offering rental properties such as www.realtor.ca or www.realtor.com or it may be a search engine parsed query returning a list of local property management companies offering residential rental properties allowing the user to then navigate to these, browse etc. and maintain the conversation with the ACESAP.

It would be evident to one skilled in the art that the implications of ACESAPs according to embodiments of the invention are broad and far-reaching, as they provide a paradigm shift of what it means to navigate a website. Instead of navigating using traditional point-and-click buttons and other navigational tools, the user is presented relevant, dynamic content in response to an ongoing conversation.

Within an ACESAP according to an embodiment of the invention a browser redirection occurs once a condition is triggered by the NLP engine or service (which dictates the ACESAP's response(s) to user input). The NLP engine or NLP service if external to the ACESAP will alert the ACESAP that a redirect or content change should happen. If the NPL engine is part of the ACESAP according to an embodiment of the invention, then this alert is internally communicated. This information can be passed as a tag, for example, within the response text from the NPL, e.g. <action:redirect, url: http://www.mywebsite.com/subpage>, or as a structured JavaScript Object Notation (JSON) element transmitted using a web service. Within other embodiments of the invention a web service may be replaced with a web socket. In general, communication between the NLP provider and ACESAP is performed using a web based communication protocol where the NLP and ACESAP are separate services or are part of the same service hosted across multiple servers including, but not limited to, locally clustered and geographically distributed. Data is transferred according to a structured format, such as that depicted in FIG. 9A for example.

Upon a redirect condition being established the browser is redirected to the new website, for example by employing JavaScript to manipulate the Browser Object Model (BOM) within the ACESAP according to an embodiment of the invention. Similarly, an ACESAP according to an embodiment of the invention may alter the content on a website by using JavaScript to modify the Document Object Model (DOM).

Within ACESAPs according to an embodiment of the invention an NLP-triggered condition to trigger an action may be undertaken using JavaScript, a web service, or a web hook, for example. This can look like, for example:
Sending an email;
Redirecting to a new web site;
Highlighting web content;
Starting an animation; and
Completing a transaction.

An ACESAP according to an embodiment of the invention, such as “ACE” for example, communicates with a base website using a web based communication protocol (commonly known as a socket), and data is transferred in some structured format, e.g. JSON. Embodiments of the invention may achieve this with web sockets implemented in JavaScript wherein the resulting communication channel allows the ACESAP, e.g. “ACE”, to make changes to the web page and redirect the user.

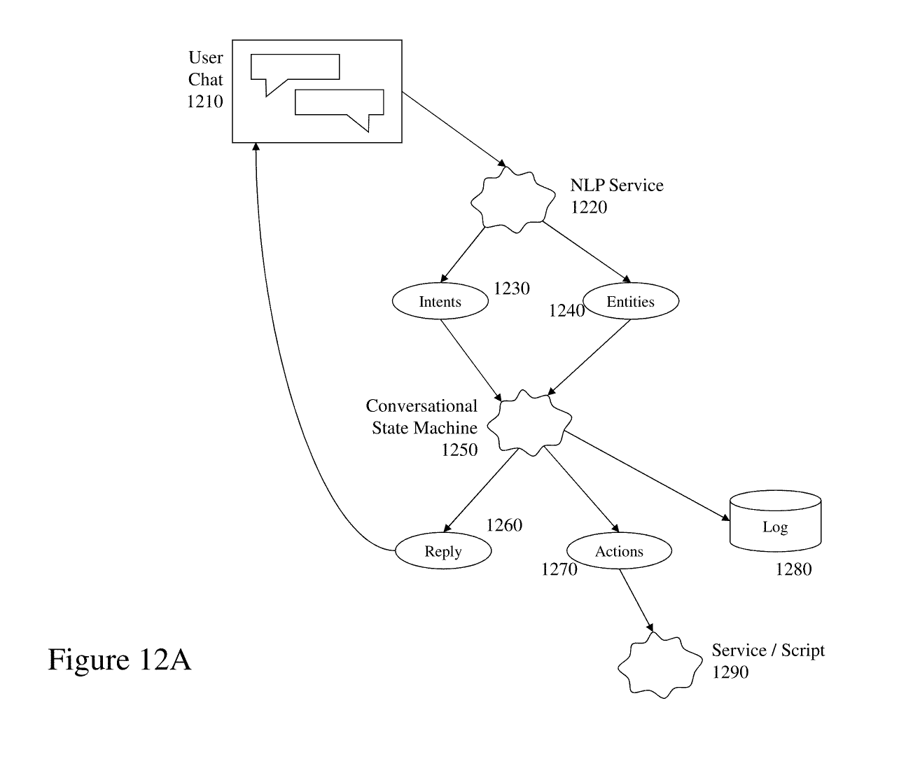

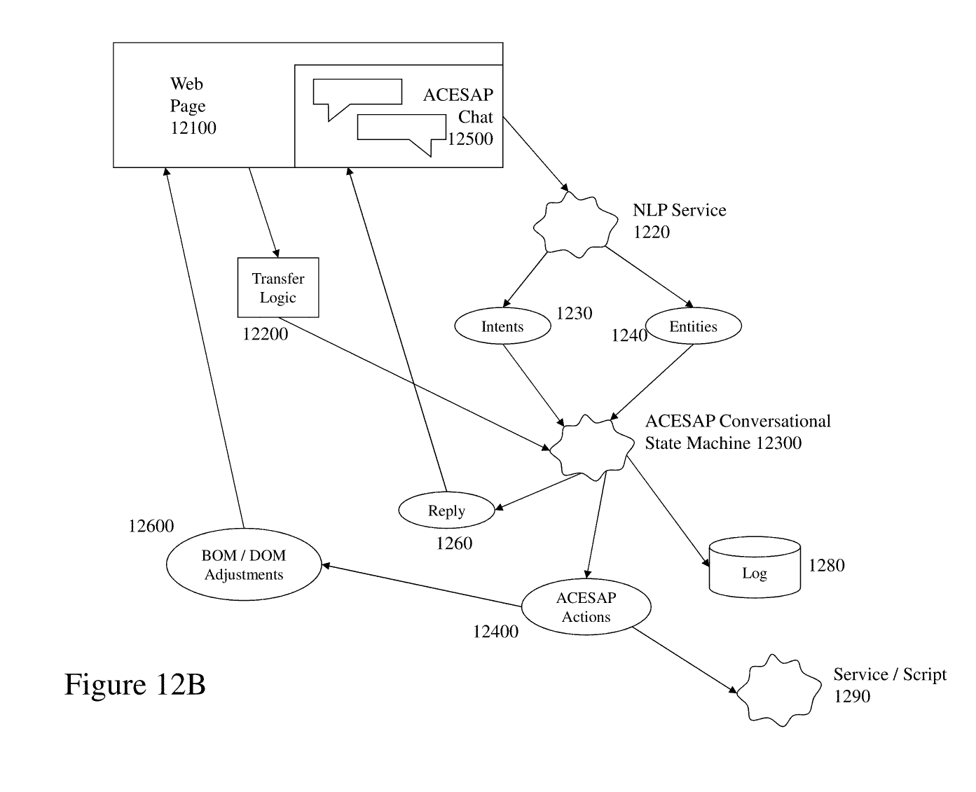

Referring to FIG. 12A there are depicted the base components required to build a prior art chatbot system. These being a user chat window 1210 which sends a user query to an NLP Service 1220 which generates Intents 1230 and Entities 1240 for transmission to a Conversational State Machine 1250. The Conversational State Machine 1250 generates a Reply 1260, Actions 1270 and stores the conversation within a Log 1280. Actions 1280 are passed to a Service/Script 1290.

In contrast, referring to FIG. 12B there are depicted the additional components required to build an ACESAP according to an embodiment of the invention. These comprise the Web Page 12100 with ACESAP Chat 12500 which is linked to Transfer Logic 12200 and therein to an ACESAP Conversational State Machine 12300 together with the Intents 1230 and Entities 1240. The ACESAP Conversational State Machine 12300 now communicates Replies 1260 to the ACESAP Chat 12500 and data to the Log 1280 and ACESAP Actions 12400. The ACESAP Actions 12400 in addition to communications with the Service/Script 1290 also provides BOM/DOM Adjustments 12600 to the Web Page 12100, as well as other browser redirection information and content as appropriate.

Accordingly, these adjustments provide the base components required for a unified ACESAP system. These base components overcome as series of potential issues including, but not limited to:
Direct/programmatic manipulation of the Conversational State Machine.
Maintaining conversational continuity/accuracy under conditions specific to a web-browser environment.
Stability of the web/browsing experience while integrated to the chatbot (for example: avoiding infinite feedback loops).

Considering initially the direct/programmatic manipulation of the Conversational State Machine then the “Conversational State Machine” is the logic that outputs text or executes an action in response to parsed input text. This can be undertaken in a variety of ways including, but not limited to, training a deep neural network, using a scripted tree-like structure, or maintaining a list of responses to certain inputs. However, regardless of the method used, a challenge the inventors overcame is the direct manipulation of this logical layer in response to web actions. In the case of a fixed language ACESAP that uses a tree-based structure then embodiments of the invention script certain actions and responses into the ACESAP logic directly. When the user takes a predefined action on the web page (for example, submitting a form) that pre-scripted intent is triggered using some connector logic, indicated in FIG. 12B as Transfer Logic 12200.

In the case of a deep-learning based neural network the inventors include annotated training data specific to the web page listeners that are being registered while training the neural net. For example, if an action we would like to listen for is submitting a web form then the inventors would annotate some training data with the output of the web listener registered to listen for this action. The trained neural network would then be able to respond to this action in the same manner as it could respond to certain verbal/text inputs.

With the ACESAP introducing a dynamic web-browser environment than another issue is maintaining conversational continuity/accuracy under conditions specific to the web-browser environment. A challenge with prior art chatbots is to have the chatbot “remember” what has been said in the past so that the chatbot does not repeat itself, or ask questions for which it should already have the answer. However, as we extend to a dynamic browser environment then the challenge is to extend this capability to the website which is hosting the ACESAP. In the sense that once a user has seen a page or certain web content then the ACESAP should be able to assume that the web page has already been seen and that the content presented is already known to the user.

To address this issue then we must extend the methods used. In the case of a neural-net based ACESAP this could mean modifying the training metrics to select against repeated content. For a fixed-language ACESAP or tree-based conversational structure, we can modify the conditions on each output such that they may only be repeated one, or some finite amount of times.

As noted supra the stability of the web/browsing experience while integrated to the ACESAP is another issue to address so that the ACESAP does not lose the conversation state. With the browsing experience integrated directly with an ACESAP, there can be many issues surrounding the stability and continuity of the chat/browser experience. Here we list some of the challenges we've faced and how these can be addressed:

It is possible that the user reloads the page, clicks the back button, or accidentally closes the window. In these cases, a dynamically generated site would lose its state, and the user would have to restart the interaction. This is especially dangerous for an ACESAP system, where the user may have already provided considerable amounts of information to the ACESAP, or has progressed to waiting “in line” for a chance to speak to a human. Accordingly, within an embodiment of the invention the inventors address this by storing a “cookie” or some other stored credential in the user's browser. This credential is linked in the ACESAP system to a conversation identity, for example each conversation has a unique identity. By linking the state of the ACESAP Conversational State Machine 12300 to this identity, the ACESAP can re-load the chat and interactive web content exactly as it was left by the user before they navigated away. This also allows the ACESAP to redirect the user to a new page without losing all the information contained in the conversation.

Another issue to consider is what happens when a user has multiple browser windows open to a page containing an ACESAP such as “ACE.” Both browser windows share the same cookie or token mentioned above, so having diverging conversations becomes an issue. An ACESAP according to an embodiment of the invention may solve this by only updating the page that has focus. If a user has multiple pages open, and changes focus from one (active page) to an inactive page, then the ACESAP updates the content on the previously-inactive page using an “OnFocus” event. The new page becomes the active page, and the page that has lost focus is not updated until it gets focus once again. This avoids issues around divergent conversations occurring on the same Conversation Identity.

Additional challenges for an ACESAP according to an embodiment of the invention include:
Translating web actions into NLP-parseable conversation inputs;
Retrieving the correct web action/content on certain conversational triggers;
Context-awareness as the ACESAP should communicate differently depending on which web page is currently open, or previous actions taken by the user; and
Logging and storing previous actions from the user alongside conversational content.

Optionally, an ACESAP according to an embodiment of the invention may support categorization and sorting of ongoing chats using metrics derived from deep neural networks. For example, filtering ongoing chats by “most impatient users”−>language used by the user is analyzed for emotional tilt, demographics, likelihood to buy, etc. This allows for chats to be filtered by inferenced qualities which are not necessarily easily defined.

Optionally, an ACESAP according to an embodiment of the invention may support a “many-to-one” use of the ACESAP such that multiple users interact with the same instance of the ACESAP, such as within the same chat room for example or within different chat rooms. Such an ACESAP opens up the possibility that the ACESAP is employed as a mediator, agent, or middle-man in a variety of situations that have not previously exploited chatbots or even chat-based interactions.

Optionally, an ACESAP according to an embodiment of the invention may support User Experience (UX) features that work between main web window and the ACE window. For example, a UX feature may be to drag and drop items to/from main page and ACE window to initiate an action, e.g. add to cart, search for alternatives, send me a copy of the specification sheets, etc.

Optionally, an ACESAP according to an embodiment of the invention may support what the inventors refer to as ACESAP layering wherein an ACESAP is employed to manage ongoing conversations. For example, an administrator ACESAP may help sort/categorize/manage ongoing chats so that agent or administrator can more easily interact with ongoing conversations. Further such ACESAPs may automate follow ups and categorization/binning of leads.

Optionally, an ACESAP according to an embodiment of the invention may exploit deep learning to infer qualities/preferences relating to the user. Accordingly, these qualities/preferences may be employed to sell targeted advertisement space/delivery within the web browser.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system comprising:
a computer comprising at least a microprocessor, a memory, a display, a user input interface and a network interface to a global communications network; wherein the memory is a non-transitory storage medium storing computer executable instructions for execution by a microprocessor; and
the computer executable instructions relate to providing:
a web browser within a graphical user interface presented to a user upon the display;
displaying at least one of a first web page and a first web site to the user in response to first user input within the web browser;
launching and rendering a first conversation interface within the at least one of the first web page and the first web site in response to second user input;
receiving third user input via the user input interface within the first conversation interface;
parsing the third user input;
triggering a request to the global communications network via the network interface for at least one of a second web page and a second web site in dependence upon the parsed third user input;
rendering the at least one of a second web page and a second web site in place of the at least one of the first web page and the first web site within the web browser with the first conversation interface within the at least one of a second web page and a second web site.

2. The system according to claim 1, wherein
the first conversation interface modifies hypertext markup language of the at least one of the first web page and the first web site it is launched and rendered within.

3. The system according to claim 1, wherein
the first conversation interface when launched directly controls the web browser.

4. The system according to claim 1, wherein
the first conversation interface when launched directly controls the web browser; and
initiates the request for the at least one of a second web page and a second web site in response to the parsed third user input.

5. The system according to claim 1, wherein
the first conversation interface modifies at least one of a document object model (DOM) and a browser object model (BOM) of the at least one of the first web page and the first web site it is launched and rendered within.

6. The system according to claim 1, wherein
a second conversation interface is associated with the at least one of the second web page and the second web site; and
the first conversation seamlessly reloads within the at least one of the second web page and the second website.

7. The system according to claim 1, wherein
the first conversation interface is launched and rendered in response to an action or a web page related action.

8. A method comprising:
providing a computer comprising at least a microprocessor, a display, a user input interface and a network interface to a global communications network; and
providing non-transitory storage medium accessible by the microprocessor storing computer executable instructions for execution by a microprocessor; wherein
the computer executable instructions relate to providing:
a web browser within a graphical user interface presented to a user upon the display;
displaying at least one of a first web page and a first web site to the user in response to first user input within the web browser;
launching and rendering a first conversation interface within the at least one of the first web page and the first web site in response to second user input;
receiving third user input via the user input interface within the first conversation interface;
parsing the third user input;
triggering a request to the global communications network via the network interface for at least one of a second web page and a second web site in dependence upon the parsed third user input;
rendering the at least one of a second web page and a second web site in place of the at least one of the first web page and the first web site within the web browser with the first conversation interface within the at least one of a second web page and a second web site.

9. The method according to claim 8, wherein
the first conversation interface modifies hypertext markup language of the at least one of the first web page and the first web site it is launched and rendered within.

10. The method according to claim 8, wherein
the first conversation interface when launched directly controls the web browser.

11. The method according to claim 8, wherein
the first conversation interface when launched directly controls the web browser; and
initiates the request for the at least one of a second web page and a second web site in response to the parsed third user input.

12. The method according to claim 8, wherein
the first conversation interface modifies at least one of a document object model (DOM) and a browser object model (BOM) of the at least one of the first web page and the first web site it is launched and rendered within.

13. The method according to claim 8, wherein
a second conversation interface is associated with the at least one of the second web page and the second web site; and
the first conversation seamlessly reloads within the at least one of the second web page and the second website.

14. The method according to claim 8, wherein
the first conversation interface is launched and rendered in response to an action or a web page related action.

15. A non-volatile non-transitory computer readable medium storing computer executable instructions for execution by a microprocessor, the instruction relating to a process comprising the steps of:
providing a web browser within a graphical user interface presented to a user upon the display;
displaying at least one of a first web page and a first web site to the user in response to first user input within the web browser;
launching and rendering a first conversation interface within the at least one of the first web page and the first web site in response to second user input;
receiving third user input via the user input interface within the first conversation interface;
parsing the third user input;
triggering a request to the global communications network via the network interface for at least one of a second web page and a second web site in dependence upon the parsed third user input;
rendering the at least one of a second web page and a second web site in place of the at least one of the first web page and the first web site within the web browser with the first conversation interface within the at least one of a second web page and a second web site.

16. The computer executable instructions according to claim 15, wherein
the first conversation interface modifies at least one:
hypertext markup language of the at least one of the first web page and the first web site it is launched and rendered within;
a document object model (DOM) of the at least one of the first web page and the first web site it is launched and rendered within; and
a browser object model (BOM) of the at least one of the first web page and the first web site it is launched and rendered within.

17. The computer executable instructions according to claim 15, wherein
the first conversation interface when launched directly controls the web browser.

18. The computer executable instructions according to claim 15, wherein
the first conversation interface when launched directly controls the web browser; and
initiates the request for the at least one of a second web page and a second web site in response to the parsed third user input.

19. The computer executable instructions according to claim 15, wherein
a second conversation interface is associated with the at least one of the second web page and the second web site; and
the first conversation seamlessly reloads within the at least one of the second web page and the second website.

20. The computer executable instructions according to claim 15, wherein
the first conversation interface is launched and rendered in response to an action or a web page related action.
